(19) United States
(12) Patent Application Publication
(10) Pub. No.: US 2011/0312506 A1
(43) Pub. Date: Dec. 22, 2011

(54) METHODS AND KITS FOR SCREENING PROTEIN SOLUBILITY

(75) Inventor: Uta Oriana von Specht, Seattle, WA (US)

(73) Assignee: Dilyx Biotechnologies, LLC, Seattle, WA (US)

(21) Appl. No.: 13/160,302

(22) Filed: Jun. 14, 2011

Related U.S. Application Data
(60) Provisional application No. 61/397,745, filed on Jun. 17, 2010.

(51) Int. Cl. C40B 20/00; G06T 11/20; B01L 3/00

(52) U.S. Cl. 506/2; 422/430; 345/440

(57) ABSTRACT

Methods and kits useful for identifying conditions which solubilize proteins and/or reduce or eliminate protein aggregation are provided. The disclosed methods and kits find utility in any number of applications requiring solubilization, formulation or storage of protein samples.

### CROSS-REFERENCE TO RELATED APPLICATIONS

The present application claims the benefit under 35 U.S.C. §119(e) of U.S. Provisional Patent Application No. 61/397,745 filed on Jun. 17, 2010 which application is incorporated herein by reference in its entirety.

### BACKGROUND

1. Technical Field

The present invention is generally related to methods and kits for screening the solubility of proteins, and the use of such methods and kits for identifying conditions which solubilize proteins and/or control or eliminate protein aggregation.

2. Description of the Related Art

The field of life science research depends on preparing samples and on the analysis of samples. Techniques and methods for sample preparation often depend on the non-aggregated state of macromolecular species in liquids, for example proteins. In an effort to improve the preparation and analysis of biological samples, it is desirable to evaluate, and in some cases, to minimize the tendency of macromolecular species to interact with each other or to aggregate. Protein aggregation is a substantial concern, especially in the field of recombinant protein production (P. Gagnon, T. Arakawa, Current Pharmaceutical Biotechnology, 2009, Vol. 10, No. 4; 347). The facile analysis of solution parameters and the preparation of liquid solution environments that diminish or foster macromolecular interaction and aggregation is therefore a useful research tool. For example, the analysis of the solubility of proteins that are used as therapeutics, diagnostics or other research tools is important to develop solution characteristics that provide an extended shelf life of products. In addition, controlled aggregation of proteins can be the basis of a useful separation methodology. Finally, many laboratory procedures depend on the dissociation of protein complexes under non-denaturating conditions. Identifying formulations that aid in dissociation of protein complexes, for instance the dissociation of antibody antigen complexes, is often an elaborate trial and error process.

During normal laboratory procedures, protein solutions may become exposed to certain stress such as elevated temperature, lowered temperature, subjection to multiple freeze/thawing cycles, long term storage, subjection to strong liquid shear with a mixer or passing through a syringe needle, exposure to strong ultraviolet light, addition of incompatible chemical reagents, exposure to surfaces or gases which results in protein precipitation or aggregation. Often such protein precipitation poses a substantial barrier to proper analysis or use as therapeutic agents since most protein purification and protein analysis processes however depend on the availability of protein solutions as a homogenous mixtures. In cases where the aggregation of a protein species is irreversible, the protein sample is typically rendered useless, creating a substantial economic loss. Strategies to suppress aggregation of protein preparations have been developed, especially via the development of formulations for a particular target protein (Chen B-L, et al. Strategies to Suppress Aggregation of Recombinant Keratinocyte Growth Factor During Liquid Formulation Development. J. Pham. Sci. 83(12) 1994: 1657-1661). However, even when such advanced strategies are applied, the preparation of a protein sample that is fit for analysis, may take many years to develop. The development of specific formulations that suppress aggregation forms the basis of their use as therapeutic agents in the form of biologic drugs (Manning M C, Patel K, Borchardt R T. Stability of Protein Pharmaceuticals. Pharm. Res. 6(11) 1989: 903-917.). The aggregation analysis of proteins is often carried out by native gel electrophoresis, size exclusion chromatography, analytical ultracentrifugation, field-flow fractionation and dynamic light scattering (Arakawa, T., Philo, J. S., Ejima, D., Tsumoto, K., Arisaka, F. Aggregation Analysis of Therapeutic Proteins, BioProcess International 4(10):42-43 (November 2006)).

In other cases it may be desirable to precipitate a particular protein for the purpose of purification or concentration. Ammonium sulphate precipitations are often used as a purification step to precipitate unwanted proteins from a complex mix of proteins, such as in the homogenized lysate of biological tissue or cells. The precipitation of globular proteins from a mixture can be reversible or irreversible. However, identification of conditions for solubilization of globular proteins while keeping them functional is difficult. The identification of excipients in biologic therapeutic formulation using reagents from the GRAS (generally accepted as safe) list involves extensive research and development, aiming to deliver protein drug formulations that minimize the aggregation of protein solutions over long periods of time (Cromwell, M. E. M., Hilario, E., Jacobson, F. Protein Aggregation and Bioprocessing, Proceedings of the 2005 AAPS Biotec Open Forum on Aggregation of Protein Therapeutics; The AAPS Journal (2006); 8(3) E572-E579). Accordingly, identifying conditions which favor aggregation or which solubilize aggregated proteins is required in any number of fields which require solubilization, formulation or storage of protein samples; however, such identification is difficult and simplified methods and/or kits for the same has yet to be developed.

Although significant progress has been made, there remains a need in the art for methods, as well as kits, which are useful for indentifying conditions which increase the solubility or proteins and/or control protein aggregation.

### BRIEF SUMMARY

The present invention is generally directed to methods and kits for solubilizing proteins. The disclosed methods and kits are useful for indentifying conditions which maintain proteins in solution or which reduce or eliminate protein aggregation, for example globular proteins. In other embodiments, the kits and methods are may be used to identify conditions which favor aggregation of proteins, for example globular proteins. Identification of such conditions may be useful in the context of protein purification for removal of unwanted proteins from solution or isolation of a desired protein in aggregate form. Alternatively, the methods and are kits are useful for indentifying conditions which solubilize a protein, for example a globular protein, which has already formed an aggregate. In certain embodiments of any of the foregoing, the protein is a globular protein. Alternatively, the methods and kits are useful for identifying conditions which aid in the dissociation of a protein complex while maintaining its individual components soluble and in native conformation. In some cases it may be beneficial, for instance to separate an antigen antibody complex into the two components antigen and antibody. The methods and kits are useful in any number research and industrial fields including, but limited to pharmaceutical research and development and protein science.

Accordingly, in one embodiment the present disclosure provides a kit for identification of conditions suitable for dissociation of a protein complex, maintaining a globular protein in solution or solubilizing an aggregated globular protein sample, the kit comprising an array of molecular cutoff filters and wells, each well independently comprising a test solution, wherein each test solution independently comprises a buffer, an additive, water or combinations thereof, wherein the kit optionally comprises appropriate instructions for use of the same for identification of conditions suitable for dissociation of a protein complex, maintaining a globular protein in solution or solubilizing an aggregated globular protein sample.

In another embodiment, the present disclosure provides a method for identifying conditions suitable for dissociation of a protein complex, maintaining a globular protein in solution or solubilizing an aggregated globular protein sample, the method comprising:

a) admixing a solubilized or aggregated globular protein sample with a plurality of test solutions in an array format to obtain a first array of test solutions;

b) subjecting the first array of test solutions to stress conditions known to promote aggregate formation;

c) passing the first array of test solutions through an array of size exclusion filters to remove insoluble material and obtain a second array of test solutions;

d) analyzing the second array of test solutions to determine the concentration of globular protein or protein complex therein; and

e) using the concentration of globular protein determined in step d) to identify conditions which dissociate the protein complex, maintain the globular protein in solution or solubilize the aggregated globular protein sample.

In yet another embodiment, the present disclosure provides a computer readable medium comprising computer executable instructions stored thereon, the computer executable instructions comprising algorithms for graphically displaying the relationship between pH, additive identity and concentration of globular protein in a test sample.

These and other aspects of the invention will be apparent upon reference to the following detailed description. To this end, various references are set forth herein which describe in more detail certain background information, procedures, compounds and/or compositions, and are each hereby incorporated by reference in their entirety.

### BRIEF DESCRIPTION OF THE DRAWINGS

FIG. 1A depicts various parts of a protein screening kit.

FIGS. 2A and 2B show a filter apparatus employed in certain screening methods.

FIG. 3 illustrates an exemplary method for identifying solubility conditions for proteins.

FIG. 4 is a diagram showing an exemplary method for identifying conditions to solubilize aggregated protein samples.

FIG. 5 is a flow chart depicting an exemplary screening method.

FIGS. 6A and 6B show results and data analysis of an exemplary screening method, respectively.

### DETAILED DESCRIPTION

### I. Definitions

In the following description, certain specific details are set forth in order to provide a thorough understanding of various embodiments. However, one skilled in the art will understand that the invention may be practiced without these details. In other instances, well-known structures have not been shown or described in detail to avoid unnecessarily obscuring descriptions of the embodiments. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The terms below, as used herein, have the following meanings, unless indicated otherwise:

“Globular protein”, also known as spheroproteins, are proteins formed by compacted amino acid chains, which are folded into intricate shapes that often roughly resemble spheres. This type of protein represents one of the three major protein groups. The two other groups are fibrous proteins, which are primarily structural proteins, and membrane proteins, which are usually found attached to the membranes of cells and their organelles. A key difference between globular proteins and fibrous proteins is that globular proteins are generally soluble in water under the right conditions, and therefore globular proteins are found in blood plasma, while fibrous proteins are not. Globular protein molecules can play many roles, for example they can be enzymes, biological messengers or transport mechanisms, and they may also serve as structural proteins within animal cells. As opposed to soluble proteins that are located in cell cytosol, organelles or as secreted forms, membrane proteins are embedded in lipid bilayer membranes, requiring detergents or amphiphile reagents to remove them from their native environment and render them soluble, typically in the form of a protein amphiphile complex (U.S. Pub. No. 2009/0270598).

“Protein Complex” is a particle comprising multiple, non covalently associated protein molecules or protein molecules that are themselves a complex with polysaccharides or nucleic acids. Such protein complexes comprise homo or hetero oligomeric proteins, protein nucleic complexes or suspended aggregates thereof. An example for such a protein complex is a complex formed by binding of an antibody to an antigen.

“Kosmotrope” refers to a chemical that contributes to the stability and structure of water-water interactions. Kosmotropes cause water molecules to favorably interact, which also stabilizes intermolecular interactions in macromolecules such as proteins. Exemplary kosmotropes include, but are not limited to, sulfate, phosphate, magnesium (2+), lithium (1+), zinc (2+) and aluminum (+3).

A “chaotrope” is an agent that disrupts the intermolecular forces between water molecules, allowing proteins and other macromolecules to dissolve more easily. Chaotropic agents interfere with stabilizing intramolecular interactions mediated by non-covalent forces such as hydrogen bonds, van der Waals forces, and hydrophobic effects. Exemplary chaotropes include, but are not limited to, calcium chloride, magnesium chloride, lithium chloride, rubidium chloride, sodium isothiocyanate, sodium iodide, sodium chlorate, sodium bromide and urea.

“Amino acid” refers to any natural or unnatural amino acid, for example arginine (Das U, Hariprasad G, Ethayathulla A S, Manral P, Das T K, et al (2007) Inhibition of Protein Aggregation: Supramolecular Assemblies of Arginine Hold the Key. PLoS ONE 2(11): e1176. doi:10.1371/journal.pone.0001176), glutamate (Golovanov, A. P. et al., 2004 A simple method for improving protein solubility and long-term stability. J. Am. Chem. Soc. 126, 8933-8939.), glycine and the like.

“Sugar” refers to a polyalcohol. Exemplary sugars include, but are not limited to, sucrose, glucose, lactose, ethylene glycol, xylitol, mannitol, inositol, sorbitol and glycerol.

“Detergent” refers to a substance having both hydrophobic and hydrophilic qualities (i.e., a surfactant). Exemplary detergents include, but are not limited to, tween 80, tween 20 and nonidet P-40.

“Reducing agent” refers to a substance capable of lowering the oxidation state of another substance. Representative reducing agents include, but are not limited to, dithiothreitol and beta mercaptoethanol.

“Oxidizing agent” refers to a substance capable of increasing the oxidation state of another substance.

“Hofmeister series” refers to a class of ions capable of salting out or salting in proteins. Representative ions from the Hofmeister series include, but are not limited to, fluoride, sulfate, hydrogen phosphate, acetate, chloride, nitrate, bromide, chlorate, perchlorate, thiocyanate, ammonium, potassium, sodium, lithium, magnesium, calcium and guanidinium (Zhang, Y., Cremer, P. S. 2006. Interactions between macromolecules and ions: the Hofmeister series. Current Opinion in Chemical Biology 10:658-663.).

### II. Kits for Protein Solubility and Aggregation Screening Methods

As noted above, the present disclosure provides a kit useful for rapid and efficient screening of protein solubility conditions. The kits are also referred to herein as OptiSol™ reagent kits. The disclosed kits are useful for identification of conditions which solubilize proteins, for example globular proteins. In another embodiment, the kits may be used for identification of conditions which will eliminate or reduce aggregation of an aggregated protein, for example a globular protein. In yet another embodiment, the kits are useful for solubilizing a protein sample which has already aggregated. In yet another embodiment, the kits are useful for identifying conditions which dissociate a protein complex. Such kits provide a quick and efficient means, heretofore unavailable, to researchers for identification of appropriate protein formulation and storage conditions.

Accordingly, in one embodiment the present disclosure is directed to a kit for identification of conditions suitable for dissociation of a protein complex, maintaining a globular protein in solution or solubilizing an aggregated globular protein sample, the kit comprising an array of molecular cutoff filters and wells, each well independently comprising a test solution, wherein each test solution independently comprises a buffer, an additive, water or combinations thereof, wherein the kit optionally comprises appropriate instructions for use of the same for identification of conditions suitable for dissociation of a protein complex, maintaining a globular protein in solution or solubilizing an aggregated globular protein sample.

In another embodiment of the kit, the buffer comprises glycine, citric acid, PIPPS, sodium acetate, Na/K phosphate, sodium citrate, bis-tris, MES. ADA, bis-tris-propane, ammonium acetate, MOPS, HEPES, tris, EPPS, imidazole, bicine, CHES, CAPS, water, PEG 1450 or combinations thereof.

In still another embodiment of the kit, the additive comprises NaCl, trehalose, TMAO, Na₂SO₄, arginine, glutamine, tween 20, solubilisin, glycerol, betaine, ammonium sulfate, acetonitrile, DDT, BME or combinations thereof.

In still other embodiments of the kit, the array is a 96 well or 384 well format. In other embodiments, the kit comprises a reaction plate, a filter plate, a collection plate or combinations thereof.

In other embodiments, the kit comprises a computer readable medium comprising computer executable instructions stored thereon, the computer executable instructions comprising algorithms for graphically displaying the relationship between pH, additive identity and concentration of globular protein in a test sample. Accordingly, a different embodiment of the present disclosure provides a computer readable medium comprising computer executable instructions stored thereon, the computer executable instructions comprising algorithms for graphically displaying the relationship between pH, additive identity and concentration of globular protein in a test sample.

In still other more specific embodiments of the kit, the array is a 96-well format, and each well independently comprises the buffer, additive or combination thereof identified for each well in Table 2 (see below).

In other embodiments of the kit, the molecular weight cutoff filter is matched to separate dissociated complexes comprising an antibody and an antigen. In some embodiments, the molecular weight cutoff filter has a molecular weight cutoff of 30 kDa, 50 kDa, 100 kDa, 200 kDa or 300 kDa. In yet other embodiments, the array is in a format suitable for use in a thermal cycler.

The presently disclosed kits address problems heretofore not solved in the art. For example, the kits provide tools to solubilize reversibly aggregated protein solutions and identify solution conditions that render protein solutions soluble in the presence of stress, such as elevated temperature (37° C. or higher) or reduced temperature (4° C. or lower), subjection to multiple freeze-thawing cycles, long-term storage (for instance 2 weeks), shear force stress (vigorous shaking or forcing the solution through a narrow bore of a needle), intense light exposure (direct sunlight or ultraviolet light for 1 hour), chemical compatibility (10 mM of caustic reagents such as heavy metals or addition of dimethylsulfoxide), surface exposure (glass beads), air (bubbling through solution) or chemical oxidation (i.e. by hydrogen peroxide). The kits and methods disclosed herein are useful for the identification of solution parameters that render globular proteins soluble in the presence of applied stresses and the conversion of reversibly aggregated globule proteins into a homogenously dissolved protein solution.

In some embodiments, the kits comprise instructions for use of the kit for two applications: Protein Solubility Profiling and Protein Aggregate Solubilization. Users either solubilize an aggregated protein solution (Application A) or select a particular sample stress (heat, freeze-thaw, storage, shear etc.) and identify those solutions that keep protein sample solubilized without aggregation. Use of the kits is described in more detail below. Data evaluation is supported with the Protein Dashboard™ as discussed below.

Proteins and Peptides remain soluble in an aqueous environment that support their particular solution requirements. Some proteins require acidic buffers of a certain pH range, others require high salt and a metabolite to stay in solution. The disclosed kits provide a tool to identify optimized solution parameters for a particular protein solution.

Proteins aggregation is an undesired process that is often caused by elevated temperature, vigorous stirring, addition of ligands or molecular binding partners or just by mere storage of a protein sample over a period of time. Protein aggregation can often be avoided with proper choice of pH, salt or stabilizing additives. The disclosed kit comprises a systematically varied array of buffers (from pH 3 to pH 10) and a series of solubility enhancers (salts, amino acids, sugars, polyols, reducing reagents) that enable the determination of conditions under which a particular protein sample is protected from aggregation or can be de-aggregated. In one embodiment, the kit comprises a total of 90 different formulations with solubility enhancers can be tested in one single, label-free experiment; and the remaining 6 experiments are positive and negative control experiments.

The kits and associates methods employ filter aided screening based on the fact that soluble proteins pass filters, aggregated proteins don't. This simple feature is exploited to in the filtration step. The wells that contain soluble proteins will yield protein after the filtration process, those with protein aggregates will not contain any protein. The accompanying Protein Dashboard™ aids in spotting protein behavior trends and identify the critical solvent factors for optimal protein solubilization. The kits allow users to establish conditions that keep the protein target in solution and are informed regarding conditions at which the protein aggregates. This enables users to choose conditions to obtain a “well behaved protein”.

Features of the disclosed kits and associated methods include:
Ability to quickly evaluate aggregation behavior as a function of pH, salt and additives
Ability to assay more than 90 different conditions in parallel and label-free
Ability to simple mix and spin protocol, no ultracentrifugation required
An opportunity to rescue reversibly aggregated protein samples
Ability to protect your protein from aggregation under stress
Ability to quickly find trends with the Protein Dashboard™

Existing methods and commercially available kits to identify conditions that provide enhanced protein solubility are inadequate, since they may render the protein non-functional by solubilization with harsh detergents such as sodium dodecyl sulfate (Wisniewski, J. R., Zougman, A., Nagaraj, N. $ Mann. M. Nat. Methods 6, 359-362 (2009) or urea, or they provide only a limited number of reagents without a device that removes incompletely solubilized material.

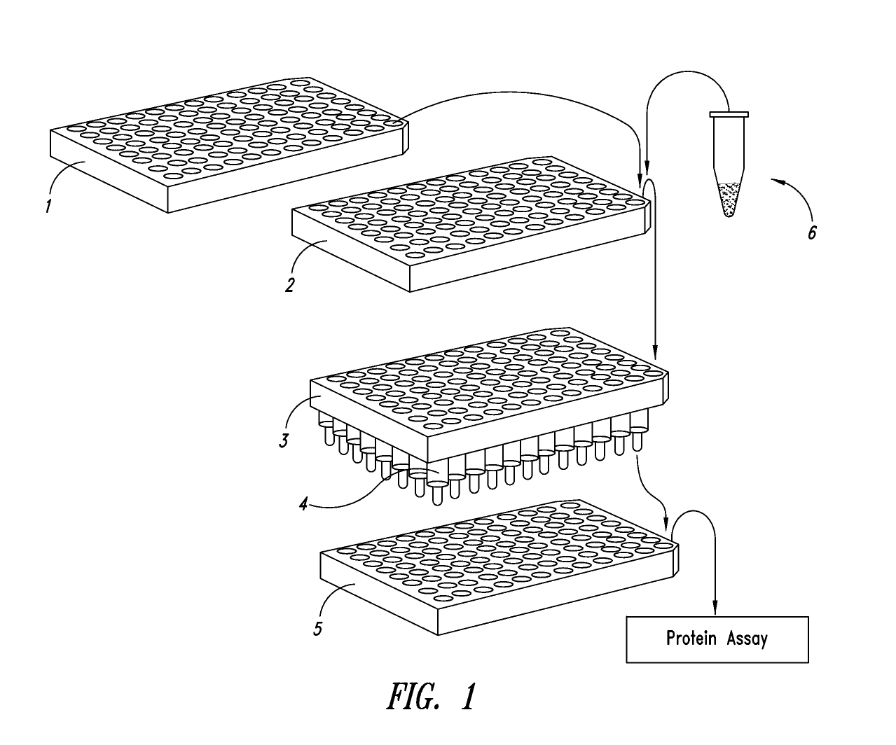

The kits may be described in reference to the Figures and the following detailed description. Referring to FIG. 1, a reagent plate 1 holding a variety of formulations (e.g., buffers, additives, controls or “blanks” or combinations thereof) is provided. In one embodiment the reagent plate 1 holds 96 different formulations. Each formulation may have a volume ranging from 200 microliters to 1500 microliters. In some embodiments, the reagent plate 1 has a format that may be commensurate with those formats endorsed by the Society of Biomolecular Screening (ANSI/SBS x-2004), i.e. having 96 wells with a separation of 9 mm from each other. The shape of each well may be that of a “U” or that of a “V”. The reagent plate 1 may be sealed to prevent loss of formulation liquid prior to handling or during shipping. In one embodiment the reagent plate 1 is a standard deep well block plate sealed with a flexible sealing mat. In another embodiment the reagent plate 1 is a PCR micro plate sealed with domed caps. The reagent plate 1 may comprise formulations of different composition as described in more detail herein.

Typical contents of the reagent plate 1 are buffers of a certain pH. The reagent plate wells may also comprise additives in addition to the buffers. For example, some formulations may comprise dissolved salts. Some formulations may comprise salts from the Hofmeister series. Some formulations may comprise dissolved polymers. Some formulations may comprise dissolved organic solvents. Some formulations may comprise reducing or oxidizing molecular species. Some formulations may comprise detergent molecules. Some formulations may comprise small molecules in the range of 50 to 700 Dalton.

The composition of the formulations of an exemplary reagent plate is given in Table 1. The arrangement of the solutions according to concentrations of solutes or pH may be carried out in a way to support facile generation of charts in the protein dashboard (i.e., data display) and to enhance the utility of the resulting data. One skilled in the art will recognize that the particular order of reagents (i.e., well number) can be changed without affecting the general use of the kits.

TABLE 1
Exemplary Formulations of a Reagent Plate.

| | | | Buffer | | | | Additive | | |
|---|---|---|---|---|---|---|---|---|---|
| Well | | | | Concentration | | pH | | Concentration | |
| # | Row | Col | | range | unit | range | NAME | range | unit |
| 1 | A | 1 | Glycine | 50-500 | mM | 2.8-3.3 | None | None | None |
| 2 | A | 2 | Citric Acid | 50-500 | mM | 3.0-3.5 | None | None | None |
| 3 | A | 3 | PIPPS | 50-500 | mM | 3.5-3.8 | None | None | None |
| 4 | A | 4 | Citric Acid | 50-500 | mM | 3.8-4.3 | None | None | None |
| 5 | A | 5 | Sodium | 50-500 | mM | 4.3-4.7 | None | None | None |
| | | | Acetate | | | | | | |
| 6 | A | 6 | Na/K | 50-500 | mM | 4.7-5.3 | None | None | None |
| | | | Phosphate | | | | | | |
| 7 | A | 7 | Sodium Citrate | 50-500 | mM | 5.3-5.8 | None | None | None |
| 8 | A | 8 | Na/K | 50-500 | mM | 5.8-6.2 | None | None | None |
| | | | Phosphate | | | | | | |
| 9 | A | 9 | Bis-Tris | 50-500 | mM | 5.8-6.2 | None | None | None |
| 10 | A | 10 | MES | 50-500 | mM | 6.0-6.5 | None | None | None |
| 11 | A | 11 | ADA | 50-500 | mM | 6.3-6.8 | None | None | None |
| 12 | A | 12 | Bis-Tris | 50-500 | mM | 6.3-6.8 | None | None | None |
| | | | Propane | | | | | | |
| 13 | B | 1 | Ammonium | 50-500 | mM | 6.8-7.3 | None | None | None |
| | | | Acetate | | | | | | |
| 14 | B | 2 | MOPS | 50-500 | mM | 6.8-7.3 | None | None | None |
| 15 | B | 3 | Na/K | 50-500 | mM | 6.8-7.3 | None | None | None |
| | | | Phosphate | | | | | | |
| 16 | B | 4 | HEPES | 50-500 | mM | 7.3-7.8 | None | None | None |
| 17 | B | 5 | Tris | 50-500 | mM | 7.3-7.8 | None | None | None |
| 18 | B | 6 | EPPS | 50-500 | mM | 7.8-8.3 | None | None | None |
| 19 | B | 7 | Imidazole | 50-500 | mM | 7.8-8.3 | None | None | None |
| 20 | B | 8 | Bicine | 50-500 | mM | 8.3-8.8 | None | None | None |
| 21 | B | 9 | Tris | 50-500 | mM | 8.3-8.8 | None | None | None |
| 22 | B | 10 | CHES | 50-500 | mM | 8.8-9.3 | None | None | None |
| 23 | B | 11 | CHES | 50-500 | mM | 9.3-9.8 | None | None | None |
| 24 | B | 12 | CAPS | 50-500 | mM | 9.8-10.5 | None | None | None |
| 25 | C | 1 | Glycine | 10-100 | mM | 2.8-3.3 | NaCl | 50-500 | mM |
| 26 | C | 2 | Sodium | 10-100 | mM | 4.3-4.7 | NaCl | 50-500 | mM |
| | | | Acetate | | | | | | |
| 27 | C | 3 | Bis-Tris | 10-100 | mM | 5.8-6.2 | NaCl | 50-500 | mM |
| 28 | C | 4 | MOPS | 10-100 | mM | 6.8-7.3 | NaCl | 50-500 | mM |
| 29 | C | 5 | Imidazole | 10-100 | mM | 7.8-7.3 | NaCl | 50-500 | mM |
| 30 | C | 6 | CHES | 10-100 | mM | 9.3-9.8 | NaCl | 50-500 | mM |
| 31 | C | 7 | Citric Acid | 10-100 | mM | 3.0-3.5 | NaCl | 500-2000 | mM |
| 32 | C | 8 | Na/K | 10-100 | mM | 4.7-5.3 | NaCl | 500-2000 | mM |
| | | | Phosphate | | | | | | |
| 33 | C | 9 | ADA | 10-100 | mM | 6.3-6.8 | NaCl | 500-2000 | mM |
| 34 | C | 10 | HEPES | 10-100 | mM | 7.3-7.8 | NaCl | 500-2000 | mM |
| 35 | C | 11 | Tris | 10-100 | mM | 8.3-8.8 | NaCl | 500-2000 | mM |
| 36 | C | 12 | CAPS | 10-100 | mM | 9.8-10.5 | NaCl | 500-2000 | mM |
| 37 | D | 1 | Glycine | 10-100 | mM | 2.8-3.3 | Trehalose | 0.5-2 | M |
| 38 | D | 2 | Sodium | 10-100 | mM | 4.3-4.7 | Trehalose | 0.5-2 | M |
| | | | Acetate | | | | | | |
| 39 | D | 3 | Bis-Tris | 10-100 | mM | 5.8-6.2 | Trehalose | 0.5-2 | M |
| 40 | D | 4 | MOPS | 10-100 | mM | 6.8-7.3 | Trehalose | 0.5-2 | M |
| 41 | D | 5 | Imidazole | 10-100 | mM | 7.8-7.3 | Trehalose | 0.5-2 | M |
| 42 | D | 6 | CHES | 10-100 | mM | 9.3-9.8 | Trehalose | 0.5-2 | M |
| 43 | D | 7 | Citric Acid | 10-100 | mM | 3.0-3.5 | TMAO | 100-1000 | mM |
| 44 | D | 8 | Na/K | 10-100 | mM | 4.7-5.3 | TMAO | 100-1000 | mM |
| | | | Phosphate | | | | | | |
| 45 | D | 9 | ADA | 10-100 | mM | 6.3-6.8 | TMAO | 100-1000 | mM |
| 46 | D | 10 | HEPES | 10-100 | mM | 7.3-7.8 | TMAO | 100-1000 | mM |
| 47 | D | 11 | Tris | 10-100 | mM | 8.3-8.8 | TMAO | 100-1000 | mM |
| 48 | D | 12 | CAPS | 10-100 | mM | 9.8-10.5 | TMAO | 100-1000 | mM |
| 49 | E | 1 | Glycine | 10-100 | mM | 2.8-3.3 | Na₂SO₄ | 200-1000 | mM |
| 50 | E | 2 | Sodium | 10-100 | mM | 4.3-4.7 | Na₂SO₄ | 200-1000 | mM |
| | | | Acetate | | | | | | |
| 51 | E | 3 | Bis-Tris | 10-100 | mM | 5.8-6.2 | Na₂SO₄ | 200-1000 | mM |
| 52 | E | 4 | MOPS | 10-100 | mM | 6.8-7.3 | Na₂SO₄ | 200-1000 | mM |
| 53 | E | 5 | Imidazole | 10-100 | mM | 7.8-7.3 | Na₂SO₄ | 200-1000 | mM |
| 54 | E | 6 | CHES | 10-100 | mM | 9.3-9.8 | Na₂SO₄ | 200-1000 | mM |
| 55 | E | 7 | Citric Acid | 10-100 | mM | 3.0-3.5 | Arg + Glu | 10-200 | mM |
| 56 | E | 8 | Na/K | 10-100 | mM | 4.7-5.3 | Arg + Glu | 10-200 | mM |
| | | | Phosphate | | | | | | |
| 57 | E | 9 | ADA | 10-100 | mM | 6.3-6.8 | Arg + Glu | 10-200 | mM |
| 58 | E | 10 | HEPES | 10-100 | mM | 7.3-7.8 | Arg + Glu | 10-200 | mM |
| 59 | E | 11 | Tris | 10-100 | mM | 8.3-8.8 | Arg + Glu | 10-200 | mM |
| 60 | E | 12 | CAPS | 10-100 | mM | 9.8-10.5 | Arg + Glu | 10-200 | mM |
| 61 | F | 1 | Glycine | 10-100 | mM | 2.8-3.3 | Tween 20 | 0.1-5 | % |
| | | | | | | | | | (w/v) |
| 62 | F | 2 | Sodium | 10-100 | mM | 4.3-4.7 | Tween 20 | 0.1-5 | % |
| | | | Acetate | | | | | | (w/v) |
| 63 | F | 3 | Bis-Tris | 10-100 | mM | 5.8-6.2 | Tween 20 | 0.1-5 | % |
| | | | | | | | | | (w/v) |
| 64 | F | 4 | MOPS | 10-100 | mM | 6.8-7.3 | Tween 20 | 0.1-5 | % |
| | | | | | | | | | (w/v) |
| 65 | F | 5 | Imidazole | 10-100 | mM | 7.8-7.3 | Tween 20 | 0.1-5 | % |
| | | | | | | | | | (w/v) |
| 66 | F | 6 | CHES | 10-100 | mM | 9.3-9.8 | Tween 20 | 0.1-5 | % |
| | | | | | | | | | (w/v) |
| 67 | F | 7 | Citric Acid | 10-100 | mM | 3.0-3.5 | Solubilisin | 10-100 | % |
| | | | | | | | | | (w/v) |
| 68 | F | 8 | Na/K | 10-100 | mM | 4.7-5.3 | Solubilisin | 10-100 | % |
| | | | Phosphate | | | | | | (w/v) |
| 69 | F | 9 | ADA | 10-100 | mM | 6.3-6.8 | Solubilisin | 10-100 | % |
| | | | | | | | | | (w/v) |
| 70 | F | 10 | HEPES | 10-100 | mM | 7.3-7.8 | Solubilisin | 10-100 | % |
| | | | | | | | | | (w/v) |
| 71 | F | 11 | Tris | 10-100 | mM | 8.3-8.8 | Solubilisin | 10-100 | % |
| | | | | | | | | | (w/v) |
| 72 | F | 12 | CAPS | 10-100 | mM | 9.8-10.5 | Solubilisin | 10-100 | % |
| | | | | | | | | | (w/v) |
| 73 | G | 1 | Glycine | 10-100 | mM | 2.8-3.3 | Glycerol | 5-50 | % |
| | | | | | | | | | (w/v) |
| 74 | G | 2 | Sodium | 10-100 | mM | 4.3-4.7 | Glycerol | 5-50 | % |
| | | | Acetate | | | | | | (w/v) |
| 75 | G | 3 | Bis-Tris | 10-100 | mM | 5.8-6.2 | Glycerol | 5-50 | % |
| | | | | | | | | | (w/v) |
| 76 | G | 4 | MOPS | 10-100 | mM | 6.8-7.3 | Glycerol | 5-50 | % |
| | | | | | | | | | (w/v) |
| 77 | G | 5 | Imidazole | 10-100 | mM | 7.8-7.3 | Glycerol | 5-50 | % |
| | | | | | | | | | (w/v) |
| 78 | G | 6 | CHES | 10-100 | mM | 9.3-9.8 | Glycerol | 5-50 | % |
| | | | | | | | | | (w/v) |
| 79 | G | 7 | Citric Acid | 10-100 | mM | 3.0-3.5 | Betaine | 0.5-2.5 | M |
| 80 | G | 8 | Na/K | 10-100 | mM | 4.7-5.3 | Betaine | 0.5-2.5 | M |
| | | | Phosphate | | | | | | |
| 81 | G | 9 | ADA | 10-100 | mM | 6.3-6.8 | Betaine | 0.5-2.5 | M |
| 82 | G | 10 | HEPES | 10-100 | mM | 7.3-7.8 | Betaine | 0.5-2.5 | M |
| 83 | G | 11 | Tris | 10-100 | mM | 8.3-8.8 | Betaine | 0.5-2.5 | M |
| 84 | G | 12 | CAPS | 10-100 | mM | 9.8-10.5 | Betaine | 0.5-2.5 | M |
| 85 | H | 1 | H2O | 100 | % | | | | |
| 86 | H | 2 | H2O | 100 | % | | | | |
| 87 | H | 3 | | | | | | | |
| 88 | H | 4 | | | | | AmSulfate | 3 | M |
| 89 | H | 5 | PEG 1450 | 5-25 | % | | NaCl | 50 | mM |
| 90 | H | 6 | | | | | Acetonitrile | 80 | % |
| | | | | | | | | | (v/v) |
| 91 | H | 7 | | | | | DDT | 0.1-2.5 | mM |
| 92 | H | 8 | | | | | DDT | 2.5-10 | mM |
| 93 | H | 9 | | | | | DDT | 10-25 | mM |
| 94 | H | 10 | | | | | BME | 0.5-5 | mM |
| 95 | H | 11 | | | | | BME | 5-15 | mM |
| 96 | H | 12 | | | | | BME | 15-25 | mM |

Abbreviations used in TABLE 1: AmSulfate, ammonium sulfate; TMAO, Trimethylamine N-Oxide; PIPPS, piperazine-N, n′-Bis (3-Propanesulfonic Acid); MES, 2-(N-morpholino) ethanesulfonic acid; MOPS, 3-(N-morpholino) propanesulfonic acid; HEPES, 4-(2-hydroxyethyl)-1-piperazineethanesulfonic acid. Arg/Glu*: 50 mM of each amino acid: Arginine and Glutamate; DDT, DL-Dithiothreitol; BME, 2-Mercaptoethanol; Betaine, Trimethyl-Glycine; CAPS, N-cyclohexyl-3-aminopropanesulfonic acid; ADA, N-(2-Acetamido)iminodiacetic Acid; Tris, tris(hydroxymethyl)aminomethane; CHES, 2-(N-Cyclohexylamino)ethane Sulfonic Acid; EPPS, N-(2-hyroxyethyl)piperazine-N′-(3-propanesulfonic acid). Solubilisin™ comprises a mixture of a non-ionic, polymeric emulsifier such as linear polyfructose grafted with lauryl residues such as Inutec SP1, and a small molecule redox reagent such as dithiothreitol (threo-1,4-dimercaptobutane-2,3-diol), and a cryoprotectant such as trehalose (α,α-trehalose, α-D-glucopyranosyl-(1-1)-α-D-glucopyranoside), and sodium chloride, wherein the Inutec SP1 concentration is in the range of 1 to 10 mg/ml, typically 5 mg/ml, the dithothreitol concentration is in the range of 1 mM to 20 mM, typically 10 mM, the trehalose concentration is in the range of 100 mM to 1000 mM, typically 500 mM and the sodium chloride concentration is between 100 mM and 2000 mM, typically 200 mM.

The pH of formulations in the reagent plate 1 may be systematically varied from pH 3 to pH 10 with buffer types overlapping in the neutral and slightly acidic or slightly basic region. Further systematic variations of the formulations may include variations in ionic strength, osmolarity, tonicity, surface tension, redox potential or combinations thereof. The formulations may comprise protein solubility enhancers such as detergents, glycerol, TMAO, Arginine, Glutamate, Trehalose, Betaine or combinations thereof. The formulations may comprise reagents that can reduce disulfide bonds. Furthermore, groupings of compounds within the reagent plate 1 into classes with similar properties or effects on protein solutions may be devised to improve the utility of the resulting data. The reagent plate 1 may also comprise formulations that serve as positive controls, such as no formulation or water only. The reagent plate may also comprise formulations that serve as negative controls, such as general protein precipitation reagents such as acetonitrile or ammonium sulfate or polyethylene glycol.

In some embodiments, the kits comprise buffer solutions ranging from pH 3 to pH 10 and 8 different chemical additives, including glycine, citric acid, 4-(2hydroxyethyl)piperazine-1-propanesulfonic acids, sodium acetate, sodium potassium phosphate, 2,2-bis-(hydroxymethyl-2,2′,2″-nitrilotriethanol, 2-(N-morpholino)ethanesulfonic acid, N-(2-acetamido)-iminodiacetic acid, cacodylate, ammonium acetate, 3-(N-morpholinopropanesulfonic acid), N-2-hydroxyethylpiperazine-N-2ethanesulfonic acid, [tris9hydroxymethyl)emino-methane, 4-(2-hydroxyethyl)piperazine-1-propanesulfonic acid, imidazole, 2(cyclohexylamino)ethanesulfonic acid, 3-(cyclyhexylamino)-1-propanesulfonate at a concentration of 100 mM. To promote the solubility of protein solutions, agents have been classified in the literature with respect to their chemical class and effect on protein solution behavior, such as kosmotropes (magnesium sulfate, ammonium sulfate, sodium sulfate, caesium sulfate), weak kosmotropes (sodium chloride, potassium chloride), chaotropes (calcium chloride, magnesium chloride, lithium chloride, rubidium chloride, sodiumisothiocyanate, sodium iodide, sodium chlorate, sodium bromide, urea), amino acids (glycine, L-arginine), sugars and polydydric alcohols (sucrose, glucose, lactose, ethylene glycol, xylitol, mannitol, inositol, sorbitol, glycerol), detergents (tween 80, tween 20, nonidet P-40), reducing reagents (dithiothreitol, beta mercaptoethanol).

In other specific embodiments, the kit comprises the buffers and additives at the pH and concentration shown in Table 2.

TABLE 2
Exemplary Embodiment of a Reagent Plate.

| | | | Buffer | | | | Additive | | |
|---|---|---|---|---|---|---|---|---|---|
| Well | | | | Concentration | | pH | | Concentration | |
| # | Row | Col | | range | unit | range | NAME | range | unit |
| 1 | A | 1 | Glycine | 100 | mM | 3.0 | None | None | None |
| 2 | A | 2 | Citric Acid | 100 | mM | 3.2 | None | None | None |
| 3 | A | 3 | PIPPS | 100 | mM | 3.7 | None | None | None |
| 4 | A | 4 | Citric Acid | 100 | mM | 4.0 | None | None | None |
| 5 | A | 5 | Sodium | 100 | mM | 4.5 | None | None | None |
| | | | Acetate | | | | | | |
| 6 | A | 6 | Na/K | 100 | mM | 5.0 | None | None | None |
| | | | Phosphate | | | | | | |
| 7 | A | 7 | Sodium Citrate | 100 | mM | 5.5 | None | None | None |
| 8 | A | 8 | Na/K | 100 | mM | 6.0 | None | None | None |
| | | | Phosphate | | | | | | |
| 9 | A | 9 | Bis-Tris | 100 | mM | 6.0 | None | None | None |
| 10 | A | 10 | MES | 100 | mM | 6.2 | None | None | None |
| 11 | A | 11 | ADA | 100 | mM | 6.5 | None | None | None |
| 12 | A | 12 | Bis-Tris | 100 | mM | 6.5 | None | None | None |
| | | | Propane | | | | | | |
| 13 | B | 1 | Ammonium | 100 | mM | 7.0 | None | None | None |
| | | | Acetate | | | | | | |
| 14 | B | 2 | MOPS | 100 | mM | 7.0 | None | None | None |
| 15 | B | 3 | Na/K | 100 | mM | 7.0 | None | None | None |
| | | | Phosphate | | | | | | |
| 16 | B | 4 | HEPES | 100 | mM | 7.5 | None | None | None |
| 17 | B | 5 | Tris | 100 | mM | 7.5 | None | None | None |
| 18 | B | 6 | EPPS | 100 | mM | 8.0 | None | None | None |
| 19 | B | 7 | Imidazole | 100 | mM | 8.0 | None | None | None |
| 20 | B | 8 | Bicine | 100 | mM | 8.5 | None | None | None |
| 21 | B | 9 | Tris | 100 | mM | 8.5 | None | None | None |
| 22 | B | 10 | CHES | 100 | mM | 9.0 | None | None | None |
| 23 | B | 11 | CHES | 100 | mM | 9.5 | None | None | None |
| 24 | B | 12 | CAPS | 100 | mM | 10.0 | None | None | None |
| 25 | C | 1 | Glycine | 50 | mM | 3.0 | NaCl | 150 | mM |
| 26 | C | 2 | Sodium | 50 | mM | 4.5 | NaCl | 150 | mM |
| | | | Acetate | | | | | | |
| 27 | C | 3 | Bis-Tris | 50 | mM | 6.0 | NaCl | 150 | mM |
| 28 | C | 4 | MOPS | 50 | mM | 7.0 | NaCl | 150 | mM |
| 29 | C | 5 | Imidazole | 50 | mM | 8.0 | NaCl | 150 | mM |
| 30 | C | 6 | CHES | 50 | mM | 9.5 | NaCl | 150 | mM |
| 31 | C | 7 | Citric Acid | 50 | mM | 3.2 | NaCl | 150 | mM |
| 32 | C | 8 | Na/K | 50 | mM | 5.0 | NaCl | 150 | mM |
| | | | Phosphate | | | | | | |
| 33 | C | 9 | ADA | 50 | mM | 6.5 | NaCl | 150 | mM |
| 34 | C | 10 | HEPES | 50 | mM | 7.5 | NaCl | 150 | mM |
| 35 | C | 11 | Tris | 50 | mM | 8.5 | NaCl | 150 | mM |
| 36 | C | 12 | CAPS | 50 | mM | 1.0 | NaCl | 150 | mM |
| 37 | D | 1 | Glycine | 50 | mM | 3.0 | Trehalose | 1.5 | M |
| 38 | D | 2 | Sodium | 50 | mM | 4.5 | Trehalose | 1.5 | M |
| | | | Acetate | | | | | | |
| 39 | D | 3 | Bis-Tris | 50 | mM | 6.0 | Trehalose | 1.5 | M |
| 40 | D | 4 | MOPS | 50 | mM | 7.0 | Trehalose | 1.5 | M |
| 41 | D | 5 | Imidazole | 50 | mM | 8.0 | Trehalose | 1.5 | M |
| 42 | D | 6 | CHES | 50 | mM | 9.5 | Trehalose | 1.5 | M |
| 43 | D | 7 | Citric Acid | 50 | mM | 3.2 | TMAO | 500 | mM |
| 44 | D | 8 | Na/K | 50 | mM | 5.0 | TMAO | 500 | mM |
| | | | Phosphate | | | | | | |
| 45 | D | 9 | ADA | 50 | mM | 6.5 | TMAO | 500 | mM |
| 46 | D | 10 | HEPES | 50 | mM | 7.5 | TMAO | 500 | mM |
| 47 | D | 11 | Tris | 50 | mM | 8.5 | TMAO | 500 | mM |
| 48 | D | 12 | CAPS | 50 | mM | 10.0 | TMAO | 500 | mM |
| 49 | E | 1 | Glycine | 50 | mM | 3.0 | Na₂SO₄ | 500 | mM |
| 50 | E | 2 | Sodium | 50 | mM | 4.5 | Na₂SO₄ | 500 | mM |
| | | | Acetate | | | | | | |
| 51 | E | 3 | Bis-Tris | 50 | mM | 6.0 | Na₂SO₄ | 500 | mM |
| 52 | E | 4 | MOPS | 50 | mM | 7.0 | Na₂SO₄ | 500 | mM |
| 53 | E | 5 | Imidazole | 50 | mM | 8.0 | Na₂SO₄ | 500 | mM |
| 54 | E | 6 | CHES | 50 | mM | 9.5 | Na₂SO₄ | 500 | mM |
| 55 | E | 7 | Citric Acid | 50 | mM | 3.2 | Arg + Glu | 50 | mM |
| 56 | E | 8 | Na/K | 50 | mM | 5.0 | Arg + Glu | 50 | mM |
| | | | Phosphate | | | | | | |
| 57 | E | 9 | ADA | 50 | mM | 6.5 | Arg + Glu | 50 | mM |
| 58 | E | 10 | HEPES | 50 | mM | 7.5 | Arg + Glu | 50 | mM |
| 59 | E | 11 | Tris | 50 | mM | 8.5 | Arg + Glu | 50 | mM |
| 60 | E | 12 | CAPS | 50 | mM | 10.0 | Arg + Glu | 50 | mM |
| 61 | F | 1 | Glycine | 50 | mM | 3.0 | Tween 20 | 1 | % |
| | | | | | | | | | (w/v) |
| 62 | F | 2 | Sodium | 50 | mM | 4.5 | Tween 20 | 1 | % |
| | | | Acetate | | | | | | (w/v) |
| 63 | F | 3 | Bis-Tris | 50 | mM | 6.0 | Tween 20 | 1 | % |
| | | | | | | | | | (w/v) |
| 64 | F | 4 | MOPS | 50 | mM | 7.0 | Tween 20 | 1 | % |
| | | | | | | | | | (w/v) |
| 65 | F | 5 | Imidazole | 50 | mM | 8.0 | Tween 20 | 1 | % |
| | | | | | | | | | (w/v) |
| 66 | F | 6 | CHES | 50 | mM | 9.5 | Tween 20 | 1 | % |
| | | | | | | | | | (w/v) |
| 67 | F | 7 | Citric Acid | 50 | mM | 3.2 | Solubilisin | 50 | % |
| | | | | | | | | | (w/v) |
| 68 | F | 8 | Na/K | 50 | mM | 5.0 | Solubilisin | 50 | % |
| | | | Phosphate | | | | | | (w/v) |
| 69 | F | 9 | ADA | 50 | mM | 6.5 | Solubilisin | 50 | % |
| | | | | | | | | | (w/v) |
| 70 | F | 10 | HEPES | 50 | mM | 7.5 | Solubilisin | 50 | % |
| | | | | | | | | | (w/v) |
| 71 | F | 11 | Tris | 50 | mM | 8.5 | Solubilisin | 50 | % |
| | | | | | | | | | (w/v) |
| 72 | F | 12 | CAPS | 50 | mM | 10.0 | Solubilisin | 50 | % |
| | | | | | | | | | (w/v) |
| 73 | G | 1 | Glycine | 50 | mM | 3.0 | Glycerol | 20 | % |
| | | | | | | | | | (w/v) |
| 74 | G | 2 | Sodium | 50 | mM | 4.5 | Glycerol | 20 | % |
| | | | Acetate | | | | | | (w/v) |
| 75 | G | 3 | Bis-Tris | 50 | mM | 6.0 | Glycerol | 20 | % |
| | | | | | | | | | (w/v) |
| 76 | G | 4 | MOPS | 50 | mM | 7.0 | Glycerol | 20 | % |
| | | | | | | | | | (w/v) |
| 77 | G | 5 | Imidazole | 50 | mM | 8.0 | Glycerol | 20 | % |
| | | | | | | | | | (w/v) |
| 78 | G | 6 | CHES | 50 | mM | 9.5 | Glycerol | 20 | % |
| | | | | | | | | | (w/v) |
| 79 | G | 7 | Citric Acid | 50 | mM | 3.2 | Betaine | 2 | M |
| 80 | G | 8 | Na/K | 50 | mM | 5.0 | Betaine | 2 | M |
| | | | Phosphate | | | | | | |
| 81 | G | 9 | ADA | 50 | mM | 6.5 | Betaine | 2 | M |
| 82 | G | 10 | HEPES | 50 | mM | 7.5 | Betaine | 2 | M |
| 83 | G | 11 | Tris | 50 | mM | 8.5 | Betaine | 2 | M |
| 84 | G | 12 | CAPS | 50 | mM | 10.0 | Betaine | 2 | M |
| 85 | H | 1 | H2O | 100 | % | | | | |
| 86 | H | 2 | H2O | 100 | % | | | | |
| 87 | H | 3 | | | | | | | |
| 88 | H | 4 | | | | | AmSulfate | 3 | M |
| 89 | H | 5 | PEG 1450 | 10 | % | | NaCl | 50 | mM |
| 90 | H | 6 | | | | | Acetonitrile | 80 | % |
| | | | | | | | | | (v/v) |
| 91 | H | 7 | | | | | DDT | 1 | mM |
| 92 | H | 8 | | | | | DDT | 5 | mM |
| 93 | H | 9 | | | | | DDT | 15 | mM |
| 94 | H | 10 | | | | | BME | 2.5 | mM |
| 95 | H | 11 | | | | | BME | 10 | mM |
| 96 | H | 11 | | | | | BME | 20 | mM |

In other embodiments, the kit comprises an array of 80-96 different formulations, typically 90 different formulations. Each formulation is associated with a particular well in an SBS-format plate. The formulation array comprises buffers such as piperazine-N, n′-Bis (3-Propanesulfonic Acid), 2-(N-morpholino) ethanesulfonic acid, 3-(N-morpholino) propanesulfonic acid, 4-(2-hydroxyethyl)-1-piperazineethanesulfonic acid, N-cyclohexyl-3-aminopropanesulfonic acid, N-(2-Acetamido)iminodiacetic Acid, tris(hydroxymethyl)aminomethane, 2-(N-Cyclohexylamino)ethane Sulfonic Acid, EPPS, N-(2-hyroxyethyl)piperazine-N′-(3-propanesulfonic acid) and additives such as Arginine and Glutamate, trehalose, DL-Dithiothreitol, 2-Mercaptoethanol, Trimethyl-Glycine, Trimethylamine N-Oxide, sodium chloride, sodium sulfate, Tween detergent, glycerol and betaine. Solubilisin comprises a mixture of a non-ionic, polymeric emulsifier such as linear polyfructose grafted with lauryl residues such as Inutec SP1, and a small molecule redox reagent such as dithiothreitol (threo-1,4-dimercaptobutane-2,3-diol), and a cryoprotectant such as trehalose (α,α-trehalose, α-D-glucopyranosyl-(1-1)-α-D-glucopyranoside), and sodium chloride, wherein the Inutec SP1 concentration is in the range of 1 to 10 mg/ml, typically 5 mg/ml, the dithothreitol concentration is in the range of 1 mM to 20 mM, typically 10 mM, the trehalose concentration is in the range of 100 mM to 1000 mM, typically 500 mM and the sodium chloride concentration is between 100 mM and 2000 mM, typically 200 mM.

The protein solubility kit may also comprise a reaction plate 2. In one embodiment the reaction plate 2 comprises wells capable of holding 96 different reactions with a volume of 1 microliter to 1500 microliters of volume each. The reaction plate 2 has a format that may also be commensurate with those formats that are endorsed by the Society of Biomolecular Screening, having 96 wells with a separation of 9 mm from each other. The shape of each well is that of a “U” or that of a “V”. The reaction plate 2 may be sealed to prevent loss of reactants during the assay.

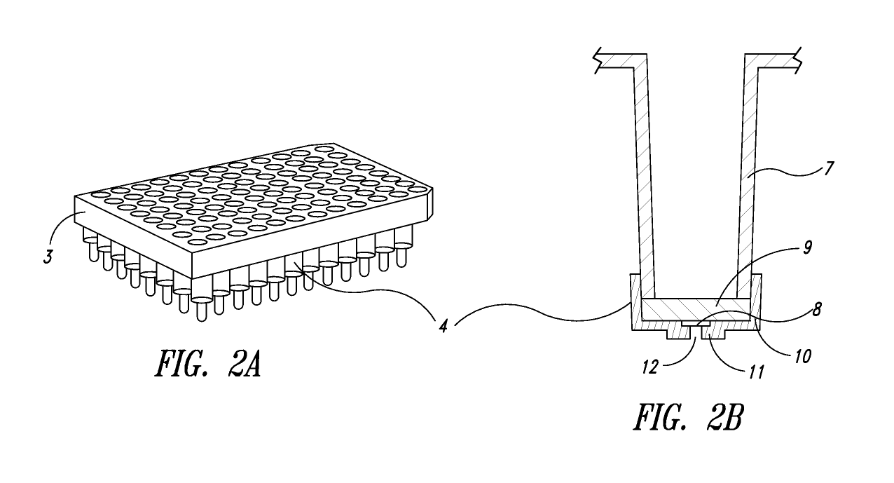

The protein solubility kit may also comprise a filter plate 3. In one embodiment the filter plate 3 comprises wells capable of holding 96 different reactions with a volume of 1 microliter to 1500 microliter of volume each. The filter plate 3 may comprise a format that is commensurate with those formats that may be endorsed by the Society of Biomolecular Screening, having 96 wells with a separation of 9 mm from each other. The spacing of the filter units 4 (FIGS. 2A and 2B) of the filter plate 3 may match the spacing of the wells in the reaction plate 2 and match may match the spacing of the wells in the collection plate 5. The filter plate 3 and the collection plate 5 may be assembled in a stack so that liquid filled into wells of the filter plate 3 flows through the filtration units 4 into corresponding wells of the collection plate 5 during centrifugation operation with a suction device.

The filter plate 3 may comprise of 96 distinct filter units. Each filter unit 4 may comprise a cylindrical or conical filter well funnel 7 with a filter assembly attached. The filter assembly may have a molecular cutoff filter disk 8 (MWCO Filter Disk), a prefilter frit 9 and a filter disk cap 10. The prefilter frit 9 serves as a sealant as it is tightly pressed against the filter well funnel 7. The prefilter frit 9 has channels that allow liquid to pass from the filter well funnel 7 to the MWCO filter disk 8. The filter disk 8 may comprise one of the following materials: polyelthylene, polypropylene, glass fiber, hydrophilic polyvinylidene fluoride or nitrocellulose. The filter disk 8 allows the passage of small molecular species only. Filter plates 3 used with the protein solubility kit may comprise filters with molecular cutoff at 10 kilo Dalton, 30 kilo Dalton, 50 kilo Dalton, 150 kilo Dalton, 300 kilo Dalton. The filter disk cap 10 holds the filter disk 8 as it is clamped onto the filter well funnel 7, pressing the MWCO filter disk 8 with the prefilter frit 9 against the exit of the filter well funnel 7. Filter materials such as hydrophilic polyethersulfone, modified polyethersulfone, polyetheylene with varying molecular weight cutoff in the range of 2 kDa, 10 kDa, 30 kDa, 100 kDa, 200 kDa, 300 kDa are generally compatible with protein solutions and may be employed in any of the embodiments described herein.

Specialized filter plates are available from several commercial vendors, such as PALL Life Sciences, Millipore, Seahorse, Nunc, Micronics, Corning, Porvair, Thermo Fisher, Biorad, Waters, Qiagen, GE Healthcare. The dimensions and the positions of individual filter units in such filterplates are typically conform with specifications of the Society for Biomolecular Screening. Such filter plates house 96 or 384 individual filter units that can be operated by centrifugation or with the use of vacuum. Centrifugation is typically carried out by assembling a sandwich, with the filter plate on top and a collection plate below. The solution is filtered through the filter by spinning in a centrifuge rotor with specialized adaptors at accelerations of up to 3,000 g. Alternatively, specialized manifolds can be used that employ a vacuum that sucks solutions through the filter units of the filter plate. In both cases the solutions from individual filters are harvested in corresponding wells of a collection plate.

The protein solubility kit may also comprise a collection plate 5. In one embodiment the collection plate 5 comprises 96 wells. Each well may hold 1 microliter to 200 microliter of volume. The collection plate 5 comprises a format that is commensurate with those endorsed by the Society of Biomolecular Screening, having 96 wells with a separation of 9 mm from each other. The shape of each well may be that of a “U” or that of a “V”. The collection plate 5 may be sealed to prevent loss of filtrate after spinning and for further processing.

In one embodiment the protein solubility kit comprises a reagent plate, a reaction plate, one or more filter plates and one or more collection plates.

In some embodiments, the kit may comprise a computer readable medium comprising computer executable instructions stored thereon, the computer executable instructions comprising algorithms for graphically displaying the relationship between pH, additive identity and concentration of globular protein in a test sample. In some embodiments, this is referred to as the Protein Dashboard. The Protein Dashboard™ is a tool that aids in spotting protein behavior trends and identify the critical solvent factors for optimal protein solubilization within a single experiment. In one embodiment, the Protein Dashboard™ is Excel® based. The user copies-and-pastes output data (e.g., protein concentration) from a plate reader into the Excel®-based Protein Dashboard™ and displays target protein behavior. Data from laboratory plate readers, such as absorption or fluorescence plate readers typically provide output values in a numerical array that correspond with 12 columns and 8 rows of an SBS plate or that correspond to a simple table numbered 1 to 96, wherein the wells of a plate are numbered consecutively as if reading a text, starting from A1 to H12. Data in both of these formats can be copied from the instrument provided source file and pasted into the appropriate receiving section of the Protein Dashboard™ spreadsheet.

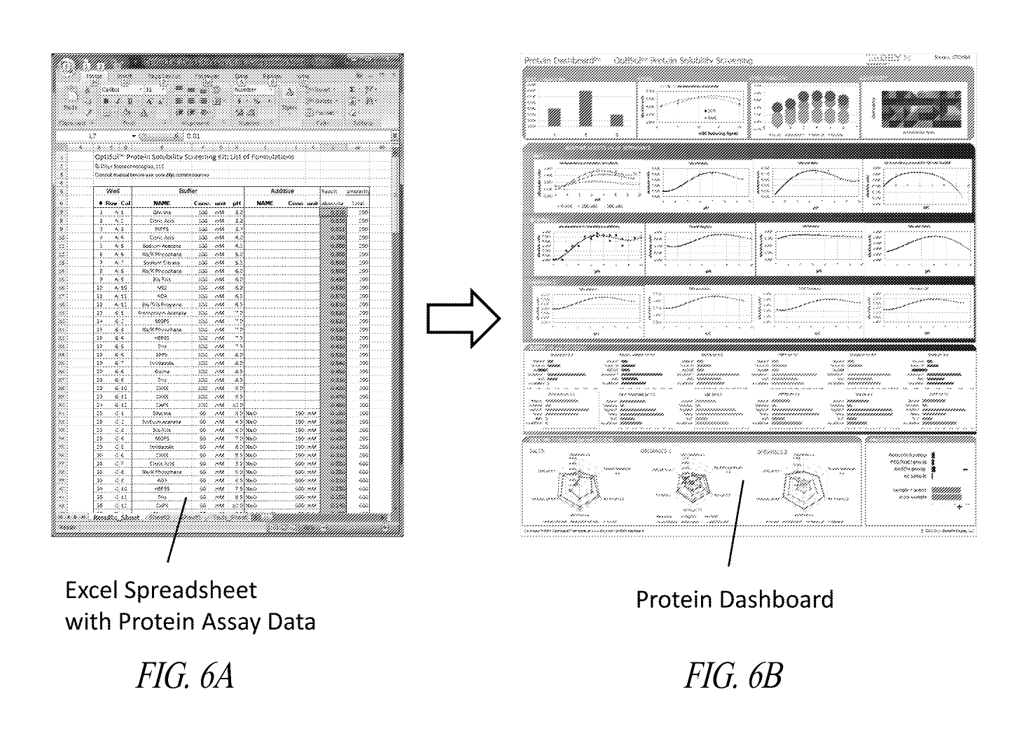

In some embodiments, the association of each formulation in the OptiSol™ reagent kit is provided within the spreadsheet and allows immediate graphing of results. The Protein Dashboard™ comprises 28 different graphs. The Protein Dashboard™ graphs the absolute or relative output data against the pH for each sodium chloride concentration (150 mM and 500 mM NaCl), for the sodium sulfate concentration, without additive, against Arg+Glu, Betaine, TMAO, Glycerol, Solubilisin, Trehalose, Tween20. For better illustration, the data points are shown as well as trend lines that are fitted to these data points. Distinct sections display the target protein solubility as a function of Salt, Charged Organics and Neutral Organics as a function of pH. Buffer pH values in combination with additives are displayed as bar graphs for each buffer. This allows to for quick selection of a particular buffer system, the optimal additive. In a separate set of three graphs data for salts, charged organics and neutral organics are displayed in a polar coordinate system. In a separate graph, the effect of redox reagents on solubility at various concentrations is shown. An example output file of the Protein Dashboard is shown in FIGS. 6A and 6B.

As opposed to other kits and methods described for use in protein solubility screening, the kits and methods described herein are applicable to globular proteins and can be applied to both, solubility profiling and to the solubilization of a precipitated protein sample. Moreover, solubility profiling that is carried out without the use of a reagent dye and in the presence of a particular solution stress, as described herein, yields formulations that protect the protein from this stress, once the formulation is applied in subsequent, ‘scaled up’ experiments. In one embodiment, the kit comprises arrayed wells in standard plates, which can be assembled into a plate stack, and if desired, can be used to adjust the temperature by simple mounting on a thermocycler (for instance a PCR thermocycler). This feature allows for simple application of a defined temperature stress.

### III. Protein Solubility and Aggregation Screening Methods

As noted above, one aspect of the present disclosure is directed to a method for identifying conditions for maintaining proteins in solution and/or solubilizing and aggregated protein. The methods are also useful for identifying conditions which eliminate or reduce protein aggregation. The methods may also be employed for identifying conditions which dissociate a protein complex. The methods find utility in the context of any protein sample, and in certain embodiments the protein sample is a globular protein. The presently disclosed methods and kits aid researchers in finding formulations that renders protein samples (e.g., globular proteins) in solution while they have been exposed to solution stresses.

One embodiment of the present disclosure is directed to a method for identifying conditions suitable for dissociation of a protein complex, maintaining a globular protein in solution or solubilizing an aggregated globular protein sample, the method comprising:

a) admixing a solubilized or aggregated globular protein sample with a plurality of test solutions in an array format to obtain a first array of test solutions;

b) subjecting the first array of test solutions to stress conditions known to promote aggregate formation;

c) passing the first array of test solutions through an array of size exclusion filters to remove insoluble material and obtain a second array of test solutions;

d) analyzing the second array of test solutions to determine the concentration of globular protein or protein complex therein; and

e) using the concentration of globular protein determined in step d) to identify conditions which dissociate the protein complex, maintain the globular protein in solution or solubilize the aggregated globular protein sample.

In certain other embodiments, the stress conditions known to promote aggregate formation are elevated temperature, long-term storage, shear force, intense light, exposure to chemicals, freeze and thaw cycles, surface exposure, chemical oxidation or reduction, air oxidation or combinations thereof. Such conditions are known in the art and described in more detail herein.

In some other embodiment of the method, the array format is a 96 or 384 well format, and in other embodiments each test solution independently has a pH ranging from 2.0 to 11.0. In still other embodiments, each test solution independently comprises a buffer, an additive or combinations thereof.

In certain embodiments, the additive comprises a kosmotrope, a chaotrope, an amino acid, a sugar, a polydydric alcohol, a detergent, a reducing agent, an oxidizing agent, a methylamine, a non-detergent sulphobetaine, a metal or combinations thereof. Exemplary additives in this regard are described in more detail herein and known by one skilled in the art.

In other embodiments of the method, the buffer has a concentration ranging from 50 to 500 mM. In yet other exemplary embodiments, the buffer comprises glycine, citric acid, PIPPS, sodium acetate, Na/K phosphate, sodium citrate, bis-tris, MES. ADA, bis-tris-propane, ammonium acetate, MOPS, HEPES, tris, EPPS, imidazole, bicine, CHES, CAPS, water, PEG 1450 or combinations thereof.

In still other embodiments, the additive comprises NaCl, trehalose, TMAO, Na₂SO₄, arginine, glutamine, tween 20, solubilisin, glycerol, betaine, ammonium sulfate, acetonitrile, DDT, BME or combinations thereof, and in other embodiments each size exclusion filter independently has a molecular weight cut off of 30 kDa or 200 kDa. In other embodiments, the filter has a molecular weight cutoff of 10 kDa, 30 kDa, 50 kDa, 150 kDa or 300 kDa. In other embodiments, the filter has a molecular weight cutoff of 30 kDa, 50 kDa, 100 kDa, 200 kDa or 300 kDa. One skilled in the art will recognize that the molecular weight cut off can be chosen based on the molecular weight of the desired protein. For example, a protein having a molecular weight of 27 kDa may be screened using a filter having a molecular weight cut off of 30 kDa. Other filters for other size proteins can be chosen similarly.

In other embodiments, the method comprises determining the concentration of globular protein or dissociated protein complex comprises a UV/vis absorption assay, a fluorescence assay, a protein assay, an enzyme assay, a western blot assay, a dot blot assay, an ELISA assay, a binding assay or a dynamic light scattering assay.

In some embodiments, identifying conditions suitable for dissociation of a protein complex, maintaining a globular protein in solution or solubilizing an aggregated globular protein sample comprises determining the combined effect of pH and additive identity on the solubility of the globular protein or the extent of association of the protein complex.

In other embodiments, the method further comprises use of a computer algorithm to graphically display the relationship between pH, additive identity and concentration of globular protein or dissociated protein in the second array of test solutions.

In still other embodiments of the method, wherein identifying conditions which maintain the globular protein in solution or solubilize the aggregated globular protein sample comprises determining the combined effect of pH and additive identity on the solubility of the globular protein or the extent of association of the protein complex. For example, such conditions may be identified by use of a computer algorithm to graphically display the relationship between pH, additive identity and concentration of globular protein in the second array of test solutions.

In some specific embodiments, the plurality of test solutions is an array in a 96-well format, and each well independently comprises the buffer, additive or combination thereof identified for each well in Table 2 (see above).

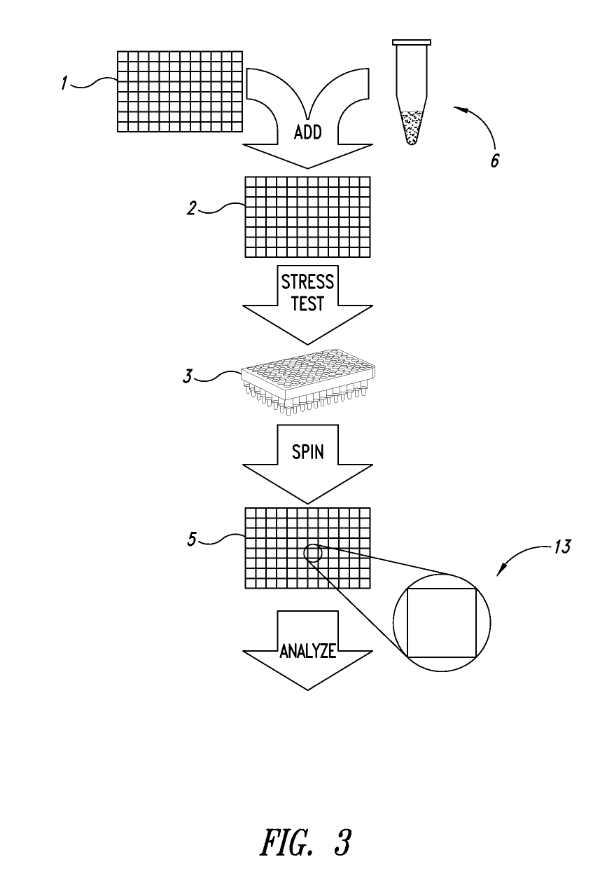

A representative method may be described by reference to the Figures. In one embodiment the protein solubility kit may be used to determine formulations that protect a particular protein sample from aggregation. (FIG. 3). Description of an exemplary method follows:

At first the seal from the reagent plate 1 is broken and 180 microliter from each well are pipetted into the corresponding well of the reaction plate 2. Then a small volume of biological sample solution 6, for example volumes of 4 microliter to 20 microliter, for example a globular protein solution, is added to each well in the reaction plate 2 by slowly pipetting the liquid while swirling the pipette tip in the solution. In cases where sample is scarce, the sample amount may be reduced to 1 microliter or less of sample solution for each well. The reaction plate 2 is then sealed with tape. The solutions in the reaction plate 2 are then exposed to a certain stress known to induce aggregation.

The user may apply one stress or several stresses, including, but not limited to: (i) incubation at elevated temperature, for example incubation at 37° C. for 24 hours, (ii) incubation at lowered temperature, for example incubation at 4° C. for 24 hours, (iii) subjection of multiple freeze/thawing cycles, (iv) long-term storage, for example storage for 4 weeks or 6 months, (v) subjection to strong liquid shear with a mixer or passing through a syringe needle, for example 50 passes through a 23 gage injection needle, (vi) exposure to intense light, for example exposure to a UV light bulb for 1 hour, (vii) addition of biological or chemical reagents such as protein samples or 1% hydrogen peroxide, (viii) exposure to surfaces, for example 100 μl of a suspension containing 10 micrometer glass beads, (ix) exposure to air or certain gases, for example purging with 1 liter of air through a needle.

Once the content of the reaction plate 2 has been subjected to the stress or multiple stresses, a volume of formulation, for example 200 microliter from each well (except well H3, which may be filled with only 20 microliter formulation) are pipetted into the corresponding well of the filter plate 3. The filter plate molecular weight cutoff is chosen to allow the passage of solubilized molecular species while aggregated protein cannot pass. A stack of plates comprising filter plate 3 on top and a collection plate 5 on bottom is assembled wherein the orientation of the wells in the plates is matched (for instance, well A1 of the filter plate should match well A1 of the collection plate). This plate stack is inserted into a centrifuge equipped with a swing bucket rotor. Alternatively, the assembly is mounted on a plate suction device. The plate stack is then spun at room temperature for ca. 15 min at 3,000 rpm. During centrifugation liquid passes from the filter units 4 in the filter plate 3 into wells of the collection plate 5. Only molecular species passing the molecular weight cutoff filter are transferred into the collection plate 5. Additional filtrations with a filter plate having a smaller molecular weight cutoff may be applied.

The amount of protein in each well of the collection plate 5 is then analyzed by subjecting small volumes of each well, for example 50 microliter of solution to an appropriate assay. Such assays may be based, amongst others, on detection of absorbed light, fluorescence or radioactivity such as Western Blot, ELISA, mass spectrometry, SDS-PAGE (sodium dodecyl sulfate poly acrylamide gel electrophoresis) ligand binding assays or a Bradford protein assay.

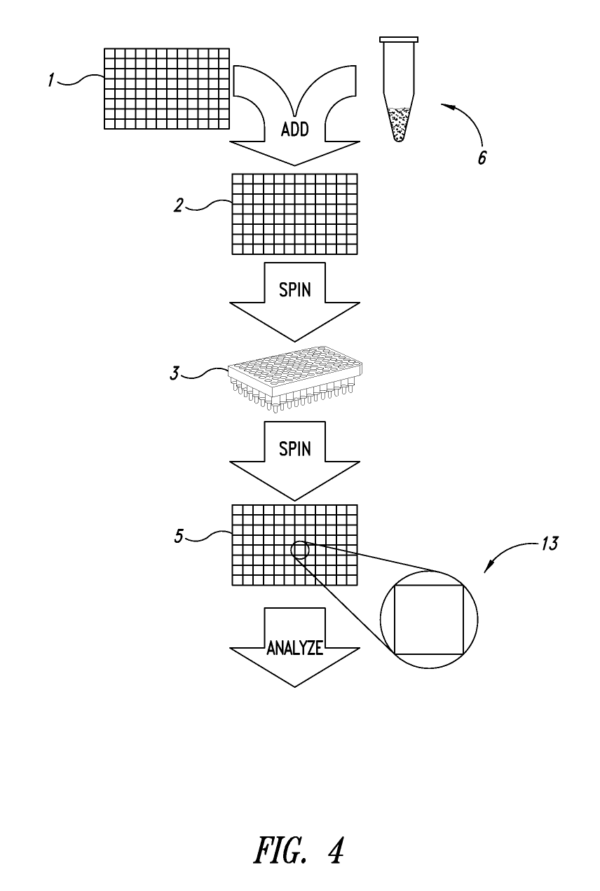

In another embodiment the protein solubility kit may be used to solubilize an aggregated biological sample. FIG. 4 depicts a representative method in this regard. At first the seal from the reagent plate 1 is broken and a small quantity, for example 10 microliter of aggregated biological sample 6 solution is added to each well in the reagent plate. It may be necessary to homogenize the biological sample 6 of aggregated protein by disrupting with ultra sonication, douncing or repeated aspiration and dispensation. The reagent plate is sealed and mixed for ca. 10 min. The liquid is collected at the bottom of each well by a short spin in a centrifuge. 200 microliters from each well are filled into the corresponding well of the filter plate. The filter plate molecular weight cutoff is chosen in a way that allows the passage only of solubilized molecular species while aggregated protein cannot pass. A stack of plates comprising a filter plate 3 on top and a collection plate 5 on bottom is assembled wherein the orientation of the wells in the plates is matched (for instance, well A1 of the filter plate should match well A1 of the collection plate). This plate stack is inserted into a centrifuge equipped with a swing bucket rotor. Alternatively, the assembly is mounted on a plate suction device. The plate stack is then spun at room temperature for ca. 15 min at 3,000 rpm.

During centrifugation liquid passes from the filter units 4 in the filter plate 3 into wells of the collection plate 5. Only molecular species passing the molecular weight cutoff filter are transferred into the collection plate. Additional filtration steps with a filter plate having a smaller molecular weight cutoff may be applied. The amount of protein in each well of the collection plate is then analyzed by subjecting small volumes of each well, for example 50 microliter of solution to an assay. Such assays may be based on detection of absorbed light, fluorescence or radioactivity such as Western Blot, ELISA, ligand binding assays or a Bradford protein assay. The remaining solutions in the collection plates contain solubilized biological samples for further experimentation.

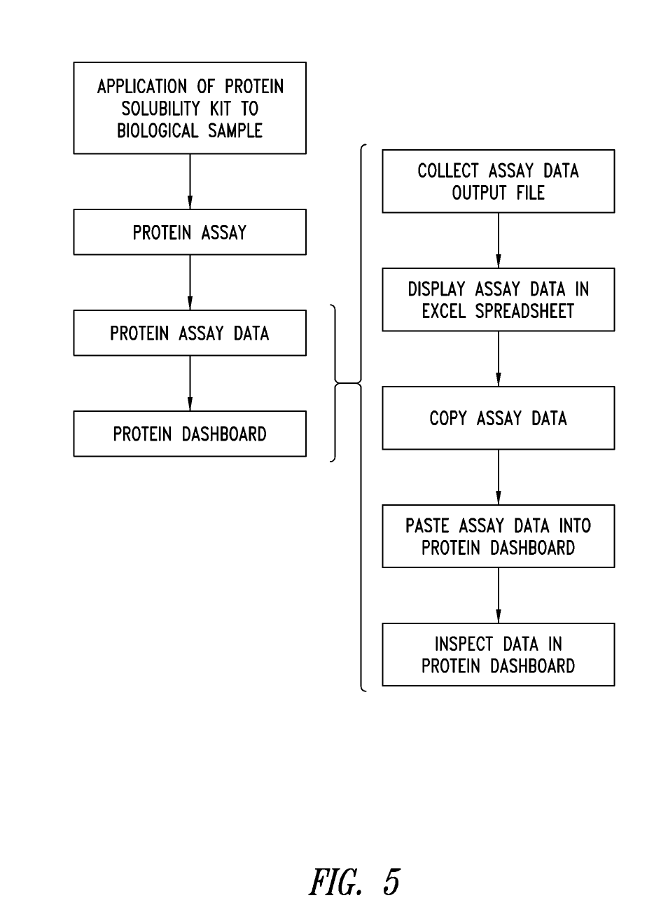

The protein solubility properties are typically measured with the protein solubility kit using a process involving several consecutive steps. FIG. 5 illustrates an exemplary method in this regard. For example, after application of a protein sample to the protein solubility kit, a protein assay is carried out to quantify the amount of protein that has passed the filter. The resulting data from the assay is typically obtained from a plate reader. In one embodiment the evaluation of the assay data is carried out with the help of software, for example the Protein Dashboard™ described above.

In one embodiment, evaluation of protein solubility may be carried out using a computer and computer software. Data from the protein assay may be collected as a data file. In one embodiment, data files comprise numerical descriptions of well position and their associated assay value (e.g., protein concentration). In some embodiments, such data may be transferred into an Excel spreadsheet by a simple copy-and-paste procedure. Once the data is pasted into the Protein Dashboard™, graphical representations of the solubility properties are displayed automatically as shown in FIGS. 6A and 6B. Such one, two or three dimensional graphical depictions include, but are not limited to: ranking of the reagents that support the solubilization or aggregation of the largest protein amounts, the solubilization amounts versus pH and the concentrations of reagents in the protein solubilization kit reagent plate.

Formulations may be grouped into classes to enhance the utility of the graphical presentation. Such groupings may include formulations with reducing or oxidizing agents, classes of varying ionic strength, classes with charged or neutral organic compounds. The generation of the graphs may be carried out by Microsoft Excel. Wells may be identified having either high or low concentrations of protein 13. The wells with the highest protein levels indicate protein solubility reagent formulations that are useful in the solubilization of biological samples. Conversely, wells with the lowest protein levels indicate formulations that are useful in the aggregation of biological samples.

The following examples are provided for purpose of illustration and not limitation.

### EXAMPLES

Unless otherwise noted otherwise in the examples, all chemicals were obtained from commercial sources and were used as supplied without further purification.

### Example 1

### Protein Solubility Profiling

This example demonstrates identification of solubility parameters that protect soluble protein samples from aggregation.

Proteins aggregate when exposed to certain stresses, and the modulation of this aggregation behavior in the presence of a variety of reagents and pH values can be analyzed with the disclosed methods and kits. A particular aggregation stress needs to be chosen, for instance elevated temperature, freeze-thawing cycles, exposure to air, long-term storage, addition of chemical reagents, surface exposure, liquid shear, intense light amongst others, to establish and analyze protein sample aggregation behavior (see Table 3 for a list with sample stresses). The screening kit and methods yield information on solution conditions that yield minimized aggregation when exposed to a particular stress. Prior to carrying out the experiment, one of the Stresses listed in Table 3 is selected and incorporated into the assay to analyze the protein's aggregation behavior.

TABLE 3
Exemplary Experimental Stresses

| Stress Type | Condition |
|---|---|
| Elevated Temperature | Incubate reagent plate for 24 hours at 37° C. |
| Long-Term Storage | Store reagent plate for 2 weeks at room |
| | temperature |
| Ice/Liquid Transition | Freeze and thaw contents of reagent plate 20 |
| | times |
| Shear Force | Force components of each well in reagent plate |
| | 20 × through narrow syringe |
| Chemical Compatibility | Add to each well in the reagent plate 10 mM of |
| | caustic reagent (i.e. heavy metal) or a reagent |
| | to test compatibility with |
| Surface Exposure | Add 5 uL of 10 um diameter glass beads to |
| | each well in the reagent plate |
| Air Oxidation | Bubble 10 ml of air through each well in the |
| | reagent plate |
| Chemical Oxidation | Add 1% Hydrogen Peroxide to each well in the |
| | reagent plate |

Allow all reagents to assume equal temperature (4° C. or room temperature). For best temperature control equilibrate all kit solutions in a temperature-controlled 96-well block. The use of a PCR Thermal Cycler set at a constant temperature is recommended. Make sure that all reagents are free of any crystallization. If crystals are observed, incubate at room or elevated temperature for several hours until inorganic crystals are dissolved

Make sure that sufficient protein sample is available to distribute into 95 equal portions. Typical sample requirements are 1-20 uL of sample/well (requiring 100 uL-2 mL of protein solution). To assay different conditions, each sample is diluted by a factor of 2-10. This dilution needs to be taken into consideration when choosing an appropriate assay (see below).

Make sure to have an assay to measure the amount of solubilized target protein. This Protocol is designed to utilize ca. 1 mg of aggregated protein sample, where the total protein concentration is 1 mg/mL and an assay will be applied that can detect quantities down to ca. 0.1 μg of protein.

Select a proper Filter Plate by matching expected particle size with MWCO (molecular weight cut off) of Filter Plate. For instance, for a monomeric protein with a MW of 50 kDa protein use the 200 kDa MWCO filter plate. If large quantities of protein solution are available, subject at first only a fraction of the protein to this solubilization protocol. This allows to first identify optimized solubilizing conditions and then, in a second step, to transfer the protein into a larger volume of the stabilizing solution.

This protocol requires approximately 2 mL of protein solution: during the course of the protocol, one hundred aliquots (20 uL) are diluted each 10-fold. The protocol can be scaled down however, simply by reducing the volume of added protein (i.e. 1 uL, requiring less than 100 uL of protein sample). The protein concentration should be as high as possible. If necessary, protein volumes in each well may be increased to 100 uL.

In the following exemplary Protein Solubility Profiling Protocol the stress test applied is elevated temperature combined with 1 day storage. Different stress tests may be used as desired.

1. Remove caps from reagent plate and transfer 150 uL from each well into the corresponding well of the Reaction Plate. Add to each well 20 uL of protein solution by slowly pipetting the volume while swirling the pipette tip in the solution. Seal plate with tape.

2. Apply the stress to test aggregation behavior. For instance, store overnight at 37° C.

3. Transfer 160 uL from each well (except the control well, which is filled with only 20 uL) into the corresponding well of the Filter Plate.

4. Assemble Filter Plate Stack by combining the Collection Plate (bottom) with the Filter Plate on top. Check orientation (e.g., well A1 of filter plate should match well A1 of the collection Plate). Insert Filter Plate Stack into swing-bucket of rotor, add counter weight as balance and spin at room temperature for ca. 15 min at 3,000 rpm.

5. Disassemble Filter Plate Stack and visually inspect if all wells (note: well H3 (control well) may contain only very little liquid) in Collection Plate are filled with liquid.

6. Subject each well of the Collection Plate to a target protein specific assay. e.g., use 50 uL of each well for a Bradford assay

Evaluation

Transfer quantitative data of protein specific assay for each well to the computer algorithm (e.g., Protein Dashboard™ spreadsheet) to obtain a visual summary of the result. This can be done simply by a cut-and-paste operation from a plate-reader output file produced on a computer, into an Excel spreadsheet, for example an excel spreadsheet identified as the Protein Dashboard™. The wells with the highest protein levels indicate solutions that maintain the protein solubilized in the presence of the stress. Such protein samples can be used for further experimentation. Note the results of positive controls (in wells H1, H2, H3) and negative controls (in wells H4, H5, H6).

If the Solubilization Screening assay was carried out with only a fraction of available material, the remaining protein solution may be protected against a particular stress by transferring the protein solution into the identified optimal solubilization solution.

Expected Results

The aggregation behavior of most proteins is highly dependent on the pH. Typically their solubility is low and their tendency to aggregate is maximal in the region of the protein's isoelectric point. Often the nature of the particular buffer contributes to the solubility of a protein at a particular pH (Chan P, Lovric J, Warwicker J: Subcellular pH and predicted pH-dependent features of proteins. Proteomics 2006, 6(12):3494-3501; Jancarik et al., 2004, Optimum solubility (OS) screening: an efficient method to optimize buffer conditions for homogeneity and crystallization of proteins. Acta Cryst D, 60:9, 1670-1673). Proteins that aggregate by forming disulfide bridges don't aggregate in the presence of DTT (H7-9) or beta-mercapto ethanol (H10-12). Elevated salt concentrations have been shown to ‘salt in’ proteins, hence increasing their solubility (Jenkins, W. T., 1998, Three solutions of the protein solubility problem. Protein Science 7(2) 376-382).

Additives such as detergent, glycerol, TMAO, Arginine and Glutamate, Trahalose and Betaine have been shown to enhance protein solubility. Their mechanism of action is not always well understood (Arakawa, T., Philo, J. S., Ejima, D., Tsumoto, K., Arisaka, F. Aggregation Analysis of Therapeutic Proteins, BioProcess International 4(10):42-43 (November 2006)).

### Example 2

### Solubilization of an Aggregated Protein Sample

This example demonstrates use of the disclosed methods and kits for identification of conditions that solubilize reversibly aggregated protein samples. Note that some protein aggregation is irreversible and can therefore usually not be properly solubilized. The Protein Solubilization kit can be used however, to assess if further attempts to de-aggregate a particular protein sample are of use (i.e. consider giving up on an aggregated protein sample if the kit does not yield any solubilized protein).

Allow all reagents to assume equal temperature (4° C. or room temperature). For best temperature control equilibrate all kit solutions in a temperature-controlled 96-well block. The use of a PCR Thermal Cycler set at a constant temperature is recommended. Make sure that all reagents are free of any crystallization. If crystals are observed, incubate at room or elevated temperature for several hours until inorganic crystals are dissolved.

Make sure that sufficient protein sample is available to distribute into 95 equal portions, and that an assay capable of measuring the amount of solubilized target protein is available. This Protocol is designed to utilize 1 mg of aggregated protein sample, where the total protein concentration is 1 mg/mL and an assay will be applied that can detect less than 0.1 μg of protein.

Select a proper Filter Plate by matching expected particle size with MWCO of Filter Plate. For instance, for a monomeric protein with a MW of 50 kDa protein use the 200 kDa MWCO filter plate. If large quantities of aggregated protein solution are available, subject at first only a fraction of the aggregated protein to this OptiSol™ solubilization protocol. This allows to first identify solubilizing conditions and then, in a second step, scale up the solubilization of the entire aggregated protein solution.

1. Prepare homogenized sample from aggregated protein solution. If a pellet is present, disrupt pellet by (bath) ultra sonication, douncing or repeated aspiration and dispensation until sample is homogenously clear or opaque.

2. Remove caps from OptiSol plate and pipette to each well 10 uL of homogenized protein aggregate solution.

3. Attach caps, mix by vortexing and incubate at room temperature for ca. 10 min.

4. Collect liquid by short spin in the centrifuge or by gently hitting the plate onto the lab bench. Transfer 160 uL from each well (except well H3, which is filled with only 10 μl) into the filter plate.

5. Assemble Filter Plate Stack by combining the Collection Plate (bottom) with the Filter Plate on top. Check orientation (well A1 of filter plate should match well A1 of the collection Plate). Insert Filter Plate Stack into swing-bucket of rotor, add counter weight as balance and spin at room temperature for ca. 15 min at 3,000 rpm.

6. Disassemble Filter Plate Stack and visually inspect if all wells in Collection Plate are filled with liquid (note: well H3 may contain only very little liquid).

7. Subject each well of Collection plate to target protein specific assay. I.e. use 50 uL of each well for a Bradford assay.

Evaluation

Transfer quantitative data of protein assay for each well to a computer algorithm (e.g. excel spreadsheet—“Protein Dashboard™”spreadsheet) to inspect a visual summary of the results. This can often be done simply by a cut-and-paste operation from a plate-reader output file produced on a computer, into the Excel spreadsheet Protein Dashboard™. The wells with the highest protein levels indicate OptiSol solutions that can solubilize the aggregated protein sample. Such protein samples can be used for further experimentation. Note that some protein aggregate is irreversibly denatured and can therefore not be properly solubilized.

If the aggregate solubilization was carried out with only a fraction of available material, the remaining aggregated protein solution may solubilized by scaling up the solubilization reaction in a linear fashion.

Expected Results

The solubility of most proteins is highly dependent on the pH. Typically, solubility is high in pH regions distant from the protein's isoelectric point. Furthermore, the nature of the particular buffer often contributes to the solubility of a protein at a particular pH (Chan P, Lovric J, Warwicker J: Subcellular pH and predicted pH-dependent features of proteins. Proteomics 2006, 6(12):3494-3501; Jancarik et al., 2004, Optimum solubility (OS) screening: an efficient method to optimize buffer conditions for homogeneity and crystallization of proteins. Acta Cryst D, 60:9, 1670-1673). Proteins that aggregate by forming disulfide bridges may be solubilized by reduction with DTT (H7-9) or BME (H10-12). Elevated salt concentrations have been shown to ‘salt in’ proteins, hence increasing their solubility Jenkins, W. T., 1998, Three solutions of the protein solubility problem. Protein Science 7(2) 376-382). Additives such as detergent, glycerol, TMAO, Arginine and Glutamate, Trehalose and Betaine have been shown to enhance protein solubility. Their mechanism of action is not always well understood (Arakawa, T., Philo, J. S., Ejima, D., Tsumoto, K., Arisaka, F. Aggregation Analysis of Therapeutic Proteins, BioProcess International 4(10):42-43 (November 2006)).

### Example 3

### Solubility Profiling of Bovine Heart Cytochrome C

Bovine heart Cytochrome C Cytochrome is a colored protein with a MW of ca. 12 kDa. Bovine heart Cytochrome C (purchased from Aldrich Sigma) was dissolved in water at a concentration of 1 mg/ml and stored for 4 days at room temperature. 150 uL from each well in the OptiSol reagent plate (see Table 2) (OptiSol 30 kit, with Molecular Weight Cut Off 30 kDa filter plate) were transferred into the Reaction Plate. To this 10 uL aliquots of the Cytochrome solution were pipetted by slowly adding the Cytochrome C solution. The Reaction plate was sealed with tape to avoid dehydration.

The aggregation behavior was tested by applying a solution stress: incubating the Reaction plate at 37 C overnight. 150 uL from each well (omitting control well H3) were transferred into the corresponding well of the filter plate. A filter plate stack was prepared by combining the Collection Plate (bottom) with the Filter plate (MWCO 30 kDa filter plate) on top and matching the orientation of the plates. This filter plate stack was spun at 15 min at room temperature at an acceleration of 3,000 rpm using a swing bucket rotor.

The Collection plate contained ca. 150 uL of solution in each well. The concentration of Cytochrome C was estimated by directly measuring its absorption in each solution at 550 nm, using a plate reader. The absorption values were transferred into the Protein Dashboard for quick inspection. Under the conditions applied (aged Cytochrome C solution, overnight incubation at 37 C) Cytochrome C has a maximum solubility at neutral pH. As seen in Table 4, the solubility is enhanced with the additives TMAO and trehalose. Data from Table 4 can be used as input to the Protein Dashboard to graphically display results (e.g., see FIG. 6B).

TABLE 4
Concentration of Cytochrome C in Each Well

| Well | | | DATA |
|---|---|---|---|
| # | Row | Col | Units |
| 1 | A | 1 | 0.033 |
| 2 | A | 2 | 0.037 |
| 3 | A | 3 | 0.040 |
| 4 | A | 4 | 0.034 |
| 5 | A | 5 | 0.031 |
| 6 | A | 6 | 0.037 |
| 7 | A | 7 | 0.035 |
| 8 | A | 8 | 0.041 |
| 9 | A | 9 | 0.048 |
| 10 | A | 10 | 0.070 |
| 11 | A | 11 | 0.090 |
| 12 | A | 12 | 0.150 |
| 13 | B | 1 | 0.200 |
| 14 | B | 2 | 0.230 |
| 15 | B | 3 | 0.240 |
| 16 | B | 4 | 0.230 |
| 17 | B | 5 | 0.240 |
| 18 | B | 6 | 0.260 |
| 19 | B | 7 | 0.240 |
| 20 | B | 8 | 0.188 |
| 21 | B | 9 | 0.185 |
| 22 | B | 10 | 0.040 |
| 23 | B | 11 | 0.020 |
| 24 | B | 12 | 0.020 |
| 25 | C | 1 | 0.035 |
| 26 | C | 2 | 0.090 |
| 27 | C | 3 | 0.400 |
| 28 | C | 4 | 0.420 |
| 29 | C | 5 | 0.410 |
| 30 | C | 6 | 0.310 |
| 31 | C | 7 | 0.020 |
| 32 | C | 8 | 0.200 |
| 33 | C | 9 | 0.210 |
| 34 | C | 10 | 0.230 |
| 35 | C | 11 | 0.150 |
| 36 | C | 12 | 0.140 |
| 37 | D | 1 | 0.335 |
| 38 | D | 2 | 0.390 |
| 39 | D | 3 | 0.700 |
| 40 | D | 4 | 0.720 |
| 41 | D | 5 | 0.710 |
| 42 | D | 6 | 0.610 |
| 43 | D | 7 | 0.125 |
| 44 | D | 8 | 0.490 |
| 45 | D | 9 | 0.820 |
| 46 | D | 10 | 0.830 |
| 47 | D | 11 | 0.720 |
| 48 | D | 12 | 0.330 |
| 49 | E | 1 | −0.210 |
| 50 | E | 2 | 0.100 |
| 51 | E | 3 | 0.120 |
| 52 | E | 4 | 0.110 |
| 53 | E | 5 | 0.010 |
| 54 | E | 6 | −0.280 |
| 55 | E | 7 | 0.335 |
| 56 | E | 8 | 0.390 |
| 57 | E | 9 | 0.700 |
| 58 | E | 10 | 0.720 |
| 59 | E | 11 | 0.710 |
| 60 | E | 12 | 0.610 |
| 61 | F | 1 | 0.112 |
| 62 | F | 2 | 0.130 |
| 63 | F | 3 | 0.233 |
| 64 | F | 4 | 0.240 |
| 65 | F | 5 | 0.237 |
| 66 | F | 6 | 0.203 |
| 67 | F | 7 | 0.037 |
| 68 | F | 8 | 0.043 |
| 69 | F | 9 | 0.078 |
| 70 | F | 10 | 0.080 |
| 71 | F | 11 | 0.079 |
| 72 | F | 12 | 0.068 |
| 73 | G | 1 | 0.050 |
| 74 | G | 2 | 0.058 |
| 75 | G | 3 | 0.104 |
| 76 | G | 4 | 0.107 |
| 77 | G | 5 | 0.105 |
| 78 | G | 6 | 0.090 |
| 79 | G | 7 | 0.300 |
| 80 | G | 8 | 0.350 |
| 81 | G | 9 | 0.360 |
| 82 | G | 10 | 0.320 |
| 83 | G | 11 | 0.340 |
| 84 | G | 12 | 0.320 |
| 85 | H | 1 | 0.010 |
| 86 | H | 2 | 0.240 |
| 87 | H | 3 | 0.010 |
| 88 | H | 4 | 0.030 |
| 89 | H | 5 | 0.300 |
| 90 | H | 6 | 0.300 |
| 91 | H | 7 | 0.210 |
| 92 | H | 8 | 0.280 |
| 93 | H | 9 | 0.230 |
| 94 | H | 10 | 0.240 |
| 95 | H | 11 | 0.320 |
| 96 | H | 12 | 0.290 |

### Example 4

### Solubilization of Aggregated Ferritin

Ferritin is a colored protein complex comprising 24 protein subunits with a total peptide Molecular Weight of 440 kDa and subunit Molecular weights of 21 and 19 kDa. Ferritin from equine spleen was obtained in saline solution (purchased from Alrich Sigma) and visible aggregation was induced by storing at room temperature for extended periods of time (i.e. more than one month). The aggregated ferritin slurry was diluted with water to 1 mg/ml and dispersed. 10 uL of the Ferritin aggregated solution were added to each well of the OptiSol Reagent plate (OptiSol 200 kit, with Molecular Weight Cut Off 200 kDa filter plate). The caps were attached and the solutions were vortexed. All liquid was collected by a short spin in a centrifuge.

150 uL from each well (except control H3) were added to the filter plate (200 kDa MWCO). A filter plate stack was assembled by combining the Collection plate (bottom) with the filter plate on top. This plate stack was spun at room temperature for 15 min at 3,000 rpm. The collection plate was used for determination of the ferritin concentration in the filtrate with a plate reader (measuring absorption at 410 nm). The absorption values were transferred into the Protein Dashboard for quick inspection. The data in Table 5 shows that under the conditions applied Ferritin aggregates can be solubilized at slightly alkaline pH. The de-aggregation is enhanced with Arginine and Glutamate and Sodium Chloride. Data from Table 5 can be used as input to the Protein Dashboard to graphically display results (e.g., see FIG. 6B).

TABLE 5
Ferritin Concentration in Each Well

| Well | | | DATA |
|---|---|---|---|
| # | Row | Col | Units |
| 1 | A | 1 | −0.002 |
| 2 | A | 2 | 0.035 |
| 3 | A | 3 | −0.043 |
| 4 | A | 4 | 0.020 |
| 5 | A | 5 | 0.014 |
| 6 | A | 6 | −0.008 |
| 7 | A | 7 | −0.001 |
| 8 | A | 8 | −0.030 |
| 9 | A | 9 | −0.038 |
| 10 | A | 10 | 0.013 |
| 11 | A | 11 | 0.038 |
| 12 | A | 12 | 0.058 |
| 13 | B | 1 | 0.169 |
| 14 | B | 2 | 0.175 |
| 15 | B | 3 | 0.186 |
| 16 | B | 4 | 0.193 |
| 17 | B | 5 | 0.217 |
| 18 | B | 6 | 0.176 |
| 19 | B | 7 | 0.202 |
| 20 | B | 8 | 0.182 |
| 21 | B | 9 | 0.109 |
| 22 | B | 10 | 0.003 |
| 23 | B | 11 | −0.046 |
| 24 | B | 12 | −0.077 |
| 25 | C | 1 | 0.035 |
| 26 | C | 2 | 0.049 |
| 27 | C | 3 | 0.322 |
| 28 | C | 4 | 0.412 |
| 29 | C | 5 | 0.323 |
| 30 | C | 6 | 0.308 |
| 31 | C | 7 | −0.014 |
| 32 | C | 8 | 0.119 |
| 33 | C | 9 | 0.181 |
| 34 | C | 10 | 0.240 |
| 35 | C | 11 | 0.210 |
| 36 | C | 12 | 0.110 |
| 37 | D | 1 | 0.138 |
| 38 | D | 2 | 0.137 |
| 39 | D | 3 | 0.230 |
| 40 | D | 4 | 0.210 |
| 41 | D | 5 | 0.279 |
| 42 | D | 6 | 0.214 |
| 43 | D | 7 | 0.001 |
| 44 | D | 8 | 0.214 |
| 45 | D | 9 | 0.265 |
| 46 | D | 10 | 0.217 |
| 47 | D | 11 | 0.232 |
| 48 | D | 12 | 0.216 |
| 49 | E | 1 | −0.176 |
| 50 | E | 2 | −0.024 |
| 51 | E | 3 | −0.002 |
| 52 | E | 4 | 0.008 |
| 53 | E | 5 | −0.049 |
| 54 | E | 6 | −0.181 |
| 55 | E | 7 | 0.116 |
| 56 | E | 8 | 0.128 |
| 57 | E | 9 | 0.297 |
| 58 | E | 10 | 0.300 |
| 59 | E | 11 | 0.289 |
| 60 | E | 12 | 0.234 |
| 61 | F | 1 | 0.002 |
| 62 | F | 2 | 0.022 |
| 63 | F | 3 | 0.044 |
| 64 | F | 4 | 0.046 |
| 65 | F | 5 | 0.095 |
| 66 | F | 6 | 0.067 |
| 67 | F | 7 | −0.041 |
| 68 | F | 8 | −0.003 |
| 69 | F | 9 | −0.006 |
| 70 | F | 10 | −0.021 |
| 71 | F | 11 | −0.044 |
| 72 | F | 12 | −0.023 |
| 73 | G | 1 | 0.002 |
| 74 | G | 2 | 0.056 |
| 75 | G | 3 | 0.029 |
| 76 | G | 4 | 0.040 |
| 77 | G | 5 | 0.240 |
| 78 | G | 6 | 0.120 |
| 79 | G | 7 | 0.096 |
| 80 | G | 8 | 0.093 |
| 81 | G | 9 | 0.123 |
| 82 | G | 10 | 0.118 |
| 83 | G | 11 | 0.136 |
| 84 | G | 12 | 0.090 |
| 85 | H | 1 | −0.064 |
| 86 | H | 2 | 0.178 |
| 87 | H | 3 | −0.044 |
| 88 | H | 4 | −0.058 |
| 89 | H | 5 | 0.270 |
| 90 | H | 6 | 0.205 |
| 91 | H | 7 | 0.150 |
| 92 | H | 8 | 0.155 |
| 93 | H | 9 | 0.165 |
| 94 | H | 10 | 0.176 |
| 95 | H | 11 | 0.232 |
| 96 | H | 12 | 0.273 |

### Example 5

### Protein Complex Dissociation

Example 5 describes the identification of solution parameters that promote the dissociation of protein complexes.

Protein complexes form amongst themselves, for instance as homodimers or homotrimers etc. or between different protein species, such as in heterodimeric complexes. Some protein complexes may form with nucleic acids such as RNA or DNA and with polysaccharides, such as glycogen. An example of a protein complex is that formed between an immunoglobulin, or antibody, and a bound antigen. The interaction of protein molecules in such complexes may be disrupted by changing the solution pH, its ionic strength, its dielectric constant or other solution parameters. One or both components of the complex may pass the molecular weight cutoff filter when dissociated, but not when the components are in a complex. For instance, provided with suitable solution conditions, a 30 MWCO filter retains a 166 kDa IgG antigen-antibody complex, comprising a 146 kDa IgG antibody and a 20 kDa antigen. However, when dissociated, the 20 kDA antigen passes through the filter and the 146 kDa antibody is retained. Thus, the screening kits and methods yield information on solution conditions that promote the dissociation of such protein complexes.

An exemplary experiment is conducted as follows. Allow all reagents to assume equal temperature (e.g., 4° C. or room temperature). For best temperature control equilibrate all kit solutions in a temperature-controlled 96-well block. The use of a PCR Thermal Cycler set at a constant temperature is recommended. Make sure that all reagents are free of any crystallization. If crystals are observed, incubate at room or elevated temperature for several hours until inorganic crystals are dissolved.

Ensure that sufficient protein complex sample is available to distribute into 95 equal portions. Typical sample requirements are 1-20 uL of protein complex sample/well (requiring 100 uL-2 mL of protein solution).

Ensure an appropriate assay is available to measure the amount of dissociated protein which passes through the molecular weight cutoff filter. This protocol is designed to utilize ca. 1 mg of protein complex sample, where the total protein concentration is 1 mg/mL and an assay will be applied that can detect quantities down to ca. 0.1 μg of protein.

Select a proper Filter Plate by matching expected particle size with MWCO (molecular weight cut off) of Filter Plate. For instance, for a monomeric protein with a MW of 20 kDa protein that is complexed with an IgG antibody of 146 kDa, use the 30 kDa MWCO filter plate. If large quantities of protein complex solution are available, subject at first only a fraction of the protein complex solution to this protocol. This allows to first identify optimized dissociation conditions and then, in a second step, to dissociate a larger batch of the protein complex by transfer into the identified dissociating solution.

This protocol requires approximately 2 mL of protein complex solution; during the course of the protocol, one hundred aliquots (20 uL) are diluted each 10-fold. The protocol can be scaled down however, simply by reducing the volume of added protein complex solution (i.e. 1 uL, requiring less than 100 uL of protein sample). The protein concentration should be as high as possible. If necessary, protein volumes in each well may be increased to 100 uL.

In the following exemplary Protein Complex Dissociation Protocol the dissociation of an IgG antibody from its 20 kDa antigen is described. Different molecular weights of antigen or antibody may require the use of a different MWCO filter plate.

1. Remove caps from reagent plate and transfer 150 uL from each well into the corresponding well of the Reaction Plate. Add to each well 20 uL of IgG antibody antigen solution at a concentration of 1 mg/mL by slowly pipetting the volume while swirling the pipette tip in the solution. Seal plate with tape.

2. Incubate at the desired temperature, for instance at room temperature over night.

3. Transfer 160 uL from each well (except the control well, which is filled with only 20 uL) into the corresponding well of the 30 MWCO Filter Plate.

4. Assemble Filter Plate Stack by combining the Collection Plate (bottom) with the Filter Plate on top. Check orientation (e.g., well A1 of filter plate should match well A1 of the collection Plate). Insert Filter Plate Stack into swing-bucket of rotor, add counter weight as balance and spin at room temperature for ca. 15 min at 3,000 rpm.

5. Disassemble Filter Plate Stack and visually inspect if all wells (note: well H3 (control well) may contain only very little liquid) in Collection Plate are filled with liquid.

6. Subject each well of the Collection Plate to a target protein specific assay. e.g., use 50 uL of each well for a Bradford assay

Evaluation

Transfer quantitative data of protein specific assay for each well to the computer algorithm (e.g., Protein Dashboard™ spreadsheet) to obtain a visual summary of the result. This can be done simply by a cut-and-paste operation from a plate-reader output file produced on a computer, into an Excel spreadsheet, for example an excel spreadsheet identified as the Protein Dashboard™. The wells with the highest protein levels indicate solutions that dissociate the protein complex. Such protein samples can be used for further experimentation. Note the results of positive controls (in wells H1, H2, H3) and negative controls (in wells H4, H5, H6).

If the Complex Dissociation Screening assay was carried out with only a fraction of available material, the remaining protein complex solution may be dissociated by adding to the protein complex solution identified dissociation solution.

Expected Results

The dissociation behavior of most protein complexes is highly dependent on the pH. Antigen and antibody complexes may be dissociated by breaking the ionic, hydrophobic and hydrogen bonds that provide the interaction energy. Additives such as detergents, glycerol, TMAO, Arginine and Glutamate, Trahalose and Betaine have been shown to effect the stability of protein complexes, although their mechanism of action is not always well understood (Arakawa, T., Philo, J. S., Ejima, D., Tsumoto, K., Arisaka, F. Aggregation Analysis of Therapeutic Proteins, BioProcess International 4(10):42-43 (November 2006)).

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A kit for identification of conditions suitable for dissociation of a protein complex, maintaining a globular protein in solution or solubilizing an aggregated globular protein sample, the kit comprising an array of molecular cutoff filters and wells, each well independently comprising a test solution, wherein each test solution independently comprises a buffer, an additive, water or combinations thereof, wherein the kit optionally comprises appropriate instructions for use of the same for identification of conditions suitable for dissociation of a protein complex, maintaining a globular protein in solution or solubilizing an aggregated globular protein sample.

2. The kit of claim 1, wherein the buffer comprises glycine, citric acid, PIPPS, sodium acetate, Na/K phosphate, sodium citrate, bis-tris, MES. ADA, bis-tris-propane, ammonium acetate, MOPS, HEPES, tris, EPPS, imidazole, bicine, CHES, CAPS, water, PEG 1450 or combinations thereof.

3. The kit of claim 1, wherein the additive comprises NaCl, trehalose, TMAO, Na₂SO₄, arginine, glutamate, tween 20, Solubilisin™, glycerol, betaine, ammonium sulfate, acetonitrile, DDT, BME or combinations thereof.

4. The kit of claim 1, wherein the array is a 96 well or 384 well format.

5. The kit of claim 1, further comprising a reaction plate, a filter plate, a collection plate or combinations thereof.

6. The kit of claim 1, further comprising a computer readable medium comprising computer executable instructions stored thereon, the computer executable instructions comprising algorithms for graphically displaying the relationship between pH, additive identity and concentration of globular protein in a test sample.

7. The kit of claim of claim 1, wherein the array is a 96-well format, and each well independently comprises the buffer, additive or combination thereof identified for each well in Table 2.

8. The kit of claim 1, wherein the molecular weight cutoff filter is matched to separate dissociated complexes comprising an antibody and an antigen.

9. The kit of claim 1, wherein the molecular weight cutoff filter has a molecular weight cutoff of 30 kDa, 50 kDa, 100 kDa, 200 kDa or 300 kDa.

10. The kit of claim 1, wherein the array is in a format suitable for use in a thermal cycler.

11. A method for identifying conditions suitable for dissociation of a protein complex, maintaining a globular protein in solution or solubilizing an aggregated globular protein sample, the method comprising:
a) admixing a solubilized or aggregated globular protein sample with a plurality of test solutions in an array format to obtain a first array of test solutions;
b) subjecting the first array of test solutions to stress conditions known to promote aggregate formation;
c) passing the first array of test solutions through an array of size exclusion filters to remove insoluble material and obtain a second array of test solutions;
d) analyzing the second array of test solutions to determine the concentration of globular protein or protein complex therein; and
e) using the concentration of globular protein determined in step d) to identify conditions which dissociate the protein complex, maintain the globular protein in solution or solubilize the aggregated globular protein sample.

12. The method of claim 11, wherein the stress conditions known to promote aggregate formation are elevated temperature, long-term storage, shear force, intense light, exposure to chemicals, freeze and thaw cycles, surface exposure, chemical oxidation or reduction, air oxidation or combinations thereof.

13. The method of claim 11, wherein the array format is a 96 or 384 well format.

14. The method of claim 11, wherein each test solution independently has a pH ranging from 2.0 to 11.0.

15. The method of claim 11, wherein each test solution independently comprises a buffer, an additive or combinations thereof.

16. The method of claim 15, wherein the additive comprises a kosmotrope, a chaotrope, an amino acid, a sugar, a polydydric alcohol, a detergent, a reducing agent, an oxidizing agent, a methylamine, a non-detergent sulphobetaine, a metal or combinations thereof.

17. The method of claim 15, wherein the buffer has a concentration ranging from 50 to 500 mM.

18. The method of claim 15, wherein the buffer comprises glycine, citric acid, PIPPS, sodium acetate, Na/K phosphate, sodium citrate, bis-tris, MES. ADA, bis-tris-propane, ammonium acetate, MOPS, HEPES, tris, EPPS, imidazole, bicine, CHES, CAPS, water, PEG 1450 or combinations thereof.

19. The method of claim 15, wherein the additive comprises NaCl, trehalose, TMAO, Na₂SO₄, arginine, glutamine, tween 20, solubilisin, glycerol, betaine, ammonium sulfate, acetonitrile, DDT, BME or combinations thereof.

20. The method of claim 11, wherein each size exclusion filter independently has a molecular weight cut off of 30 kDa, 50 kDa, 100 kDa, 200 kDa or 300 kDa.

21. The method of claim 11, wherein determining the concentration of globular protein or dissociated protein complex comprises a UV/vis absorption assay, a fluorescence assay, a protein assay, an enzyme assay, a western blot assay, a dot blot assay, an ELISA assay, a binding assay or a dynamic light scattering assay.

22. The method of claim 11, wherein identifying conditions suitable for dissociation of a protein complex, maintaining a globular protein in solution or solubilizing an aggregated globular protein sample comprises determining the combined effect of pH and additive identity on the solubility of the globular protein or the extent of association of the protein complex.

23. The method of claim 22, further comprising use of a computer algorithm to graphically display the relationship between pH, additive identity and concentration of globular protein or dissociated protein in the second array of test solutions.

24. The method of claim 11, wherein the plurality of test solutions is an array in a 96-well format, and each well independently comprises the buffer, additive or combination thereof identified for each well in Table 2.
